(19) United States
(12) Patent Application Publication
(10) Pub. No.: US 2025/0219774 A1
(43) Pub. Date: Jul. 3, 2025

(54) DUPLEX CAPABILITY INDICATION DURING INITIAL ACCESS

(71) Applicant: QUALCOMM Incorporated, San Diego, CA (US)

(72) Inventors: Ruiming ZHENG, Beijing (CN); Muhammad Sayed Khairy ABDELGHAFFAR, San Jose, CA (US); Jing LEI, San Diego, CA (US); Linhai HE, San Diego, CA (US)

(21) Appl. No.: 18/851,658

(22) PCT Filed: May 20, 2022
(86) PCT No.: PCT/CN2022/094061

§ 371 Date: Sep. 26, 2024

(51) Int. Cl. H04L 5/00; H04W 74/0833

(52) U.S. Cl. CPC H04L 5/0035; H04W 74/0833

(57) ABSTRACT

A UE may obtain an indication of an FD capability of a network node, the indication of the FD capability of the network node indicating that the network node supports an FD mode, and transmit, during an initial access procedure, an indication of an FD capability of the UE to the network node. The network node may transmit an indication of an FD capability of the network node to a UE, the indication of the FD capability of the network node indicating that the network node supports an FD mode, obtain an indication of an FD capability of the UE during an initial access procedure, and configure one or more resources for the UE based on the FD capability of the UE.

### TECHNICAL FIELD

The present disclosure relates generally to communication systems, and more particularly, to a method of wireless communication including indication of duplex capability of a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a UE and a network node. The UE may obtain an indication of a full-duplex (FD) capability of a network node, the indication of the FD capability of the network node indicating that the network node supports an FD mode, and transmit, during an initial access procedure, an indication of an FD capability of the UE to the network node. The network node may transmit an indication of an FD capability of the network node to a UE, the indication of the FD capability of the network node indicating that the network node supports an FD mode, obtain an indication of an FD capability of the UE during an initial access procedure, and configure one or more resources for the UE based on the FD capability of the UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A, 4B, and 4C illustrate example diagrams of full-duplex (FD) wireless communication.

FIG. 5 illustrates examples of full-duplex (FD) resources for FD communication.

FIG. 6 illustrates examples of integrated subframe of wireless communication.

FIGS. 7A, 7B, and 7C illustrate example diagrams of FD capability indication.

FIG. 8 is a call-flow diagram of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a diagram illustrating an example of a hardware implementation for an example network entity.

FIG. 15 is a diagram illustrating an example of a hardware implementation for an example network entity.

### DETAILED DESCRIPTION

A user equipment (UE) connected and operating in a half-duplex (HD) mode with a full-duplex (FD) network node may support certain level of FD capability. According to some aspects of the current disclosure, the UE may transmit an early indication of the UE's FD capability during the initial access procedure (e.g., random access channel (RACH) procedure) to improve the resource allocation and control at the network node.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

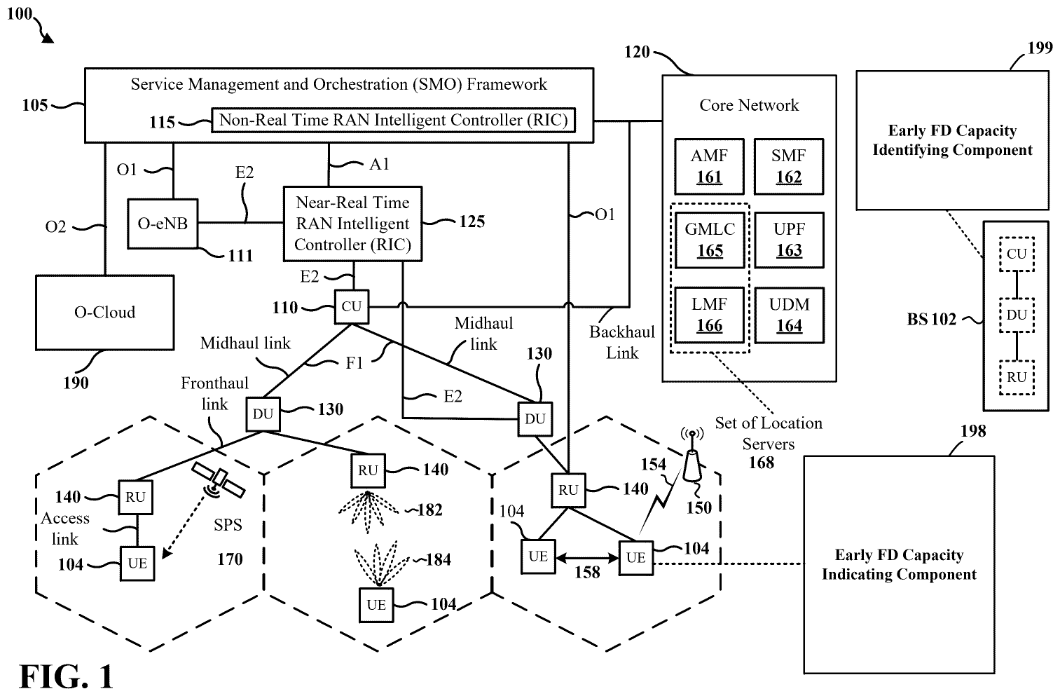

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an early FD capacity indicating component 198 configured to obtain an indication of an FD capability of a network node, the indication of the FD capability of the network node indicating that the network node supports an FD mode, and transmit, during an initial access procedure, an indication of an FD capability of the UE to the network node. In certain aspects, the base station 102 may include an early FD capacity identifying component 199 configured to transmit an indication of an FD capability of the network node for a UE, the indication of the FD capability of the network node indicating that the network node supports an FD mode, obtain an indication of an FD capability of the UE during an initial access procedure, and configure one or more resources for the UE based on the FD capability of the UE. Although the following description may be focused on 5G NR, the concepts described herein may be applicable to other similar areas, such as LTE, LTE-A, CDMA, GSM, and other wireless technologies.

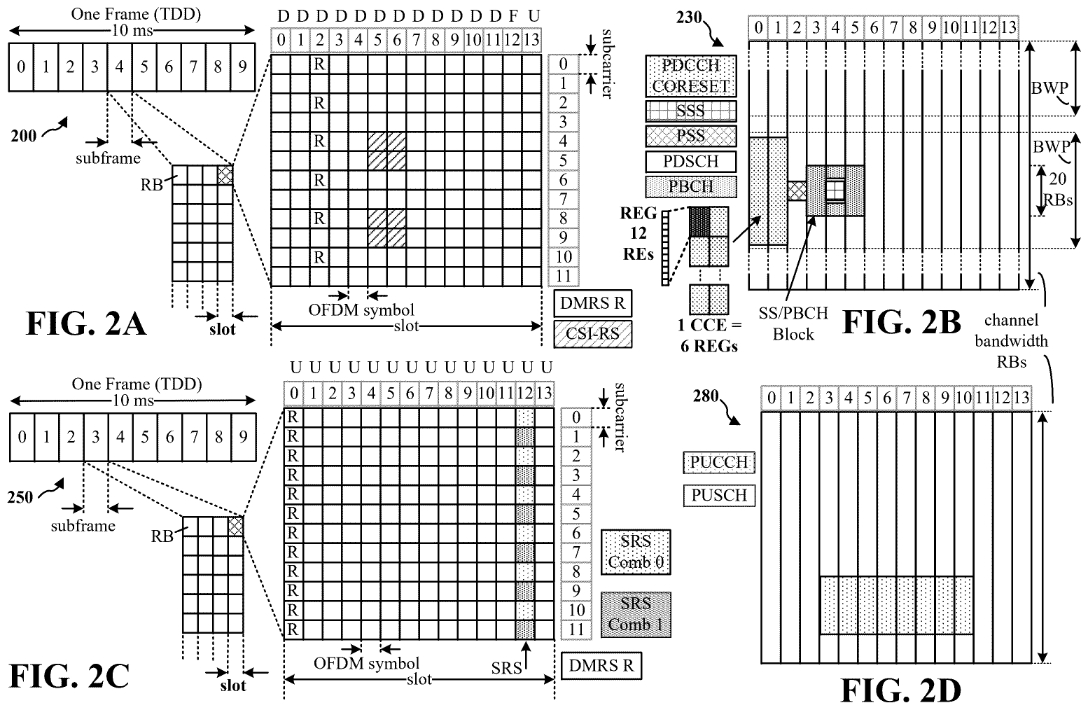

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology u=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

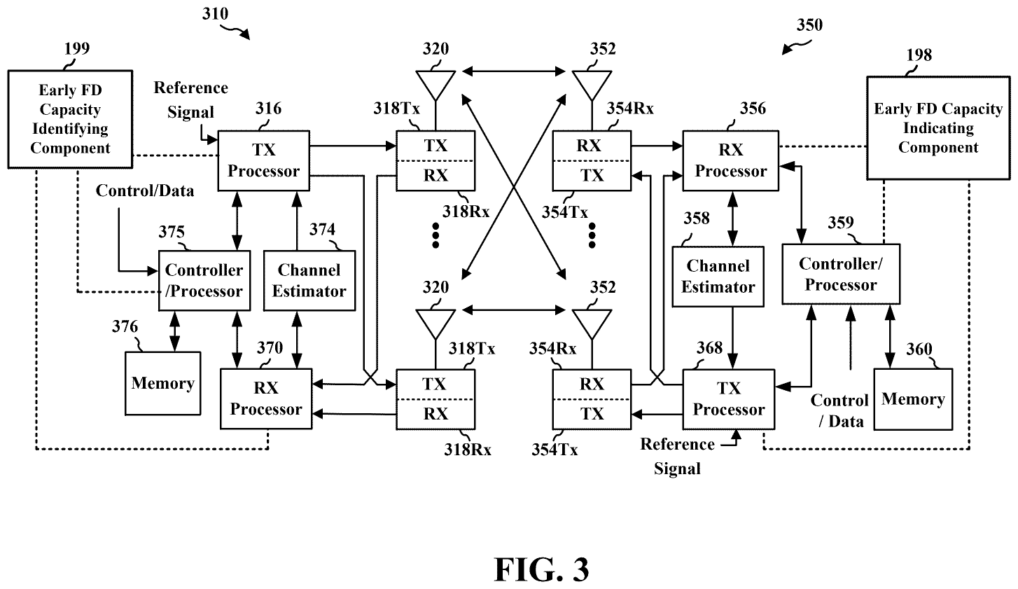

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the early FD capacity indicating component 198 of FIG. 1. At least one of the TX processor 316, the RX processor 370, and the controller/processor 375 may be configured to perform aspects in connection with the early FD capacity identifying component 199 of FIG. 1.

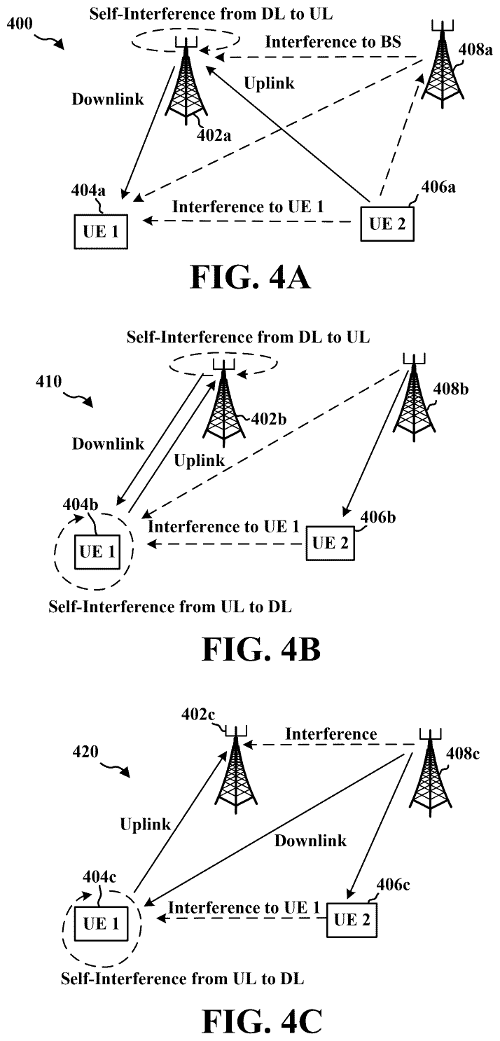

FIGS. 4A, 4B, and 4C illustrate various modes of FD communication. The HD communication may refer to transmission and reception of information in both directions, not overlapping in time. The FD communication may support transmission and reception of information over a same frequency band, or partially overlapped frequency band, or separate frequency bands that overlap in time. The FD communication may include an FD-aware HD UE, which may refer to UEs that operate in HD but are aware of FD network node. The FD-aware HD UE may support certain enhancements for a network node in FD, e.g., receive information of UL/DL sub-bands. The FD-aware HD UE may also support scheduling enhancements, e.g., FD dependent configuration. In this manner, spectral efficiency may be improved with respect to the spectral efficiency of HD communication, which supports transmission or reception of information in one direction at a time without overlapping uplink and downlink communication in time domain. Due to the simultaneous Tx/Rx nature of FD communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication, or even lead to a loss of information.

FIG. 4A shows a first example of FD communication 400 in which a first base station 402a is in FD communication with a first UE 404a and a second UE 406a. The first base station 402a is an FD base station, and the first UE 404a and the second UE 406a may be configured as either an HD UE or an FD UE. The second UE 406a may transmit a first uplink signal to the first base station 402a as well as to other base stations, such as a second base station 408a in proximity to the second UE 406a. The first base station 402a may transmit a downlink signal to the first UE 404a concurrently with receiving the uplink signal from the second UE 406a. The first base station 402a may experience self-interference at the receiving antenna that is receiving the uplink signal from the second UE 406a, the self-interference caused by some of the downlink signal being transmitted to the first UE 404a. The first base station 402a may experience additional interference due to signals from the second base station 408a. Interference may also occur at the first UE 404a based on signals from the second base station 408a as well as from uplink signals from the second UE 406a when the first UE 404a receives a downlink signal from the first base station 402a.

FIG. 4B shows a second example of FD communication 410 in which a first base station 402b is in FD communication with a first UE 404b. In this example, the first base station 402b is an FD base station and the first UE 404b is an FD UE. The first base station 402b and the first UE 404b that can concurrently receive and transmit communication that overlaps in time in a same frequency band. The base station and the UE in FD mode may each experience self-interference, in which a transmitted signal from the device may be leaked to a receiver at the same device. The first base station 402b may experience self-interference at the receiving antenna that is receiving the uplink signal from first UE 404b, the self-interference caused by some of the downlink signal being transmitted to the first UE 404a. The first UE 404b may experience self-interference at the receiving antenna that is receiving the downlink signal from first base station 402b, the self-interference caused by some of the uplink signal transmitted to the first base station 402b. The first UE 404b may experience additional interference based on one or more signals emitted from a second UE 406b and/or a second base station 408b in proximity to the first UE 404b.

FIG. 4C shows a third example of FD communication 420 in which a first UE 404c is an FD UE in communication with a first base station 402c and a second base station 408c. The first base station 402c and the second base station 408c may serve as multiple transmission and reception points (multi-TRPs) for UL and DL communication with the first UE 404c. The second base station 408c may be in communication with a second UE 406c. In FIG. 4C, the first UE 404c may concurrently transmit an uplink signal to the first base station 402c while receiving a downlink signal from the second base station 408c. The first UE 404c may experience self-interference as a result of the first signal and the second signal being communicated simultaneously. For example, the uplink signal transmitted by the UE's transmitter may be leaked to (or be received by) the UE's receiver, and the first UE 404c may experience self-interference at the receiving antenna receiving the downlink signal from second base station 408c, the self-interference caused by some of the uplink signal transmitted to the first base station 402b. The first UE 404c may experience additional interference from the second UE 406c. The first base station 402c may experience additional interference from the downlink signal transmitted by the second base station 408c.

The FD communication may be configured in a same frequency band. The uplink and downlink communication may be in different frequency sub-bands, in the same frequency sub-band, or in partially overlapping frequency sub-bands.

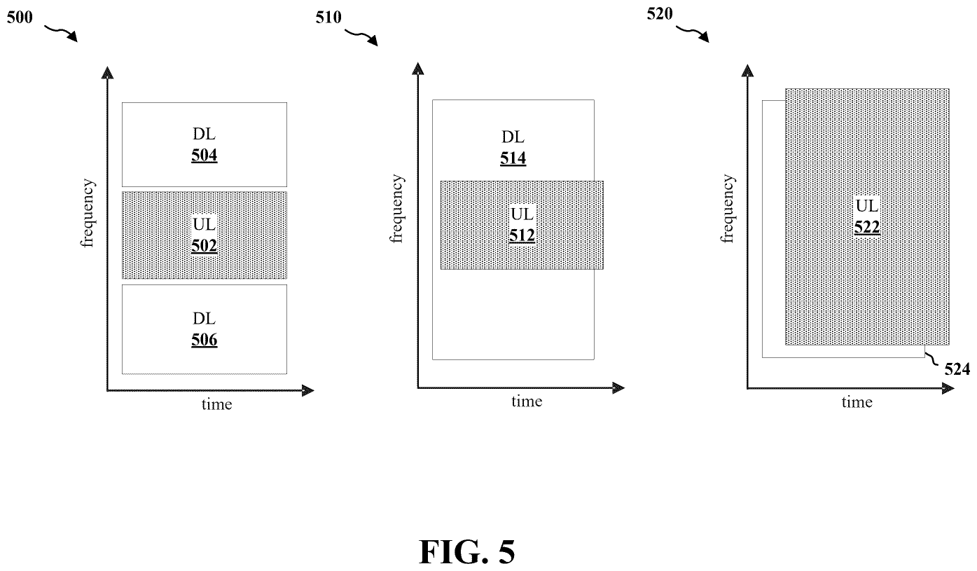

FIG. 5 illustrates a first example 500 of sub-band FD (SBFD) resources and a second example 510 and a third example 520 of in-band FD (IBFD) resources. The first example 500 illustrates the SBFD resources, where the uplink and the downlink resources may overlap in time using different frequencies. That is, the SBFD resources may include at least one uplink resources allocated in a first set of sub-bands and at least one downlink resources allocated in a second set of sub-bands overlapping in the time domain, while the first set of sub-bands and the second set of sub-bands not overlapping each other in the frequency domain. In the first example 500, the DL resources 504 and 506 may be separated from the UL resources 502 by guard bands. The guard bands may be frequency resources, or a gap in frequency resources, provided between the DL resources 504 and 506 and the UL resources 502. Separating the UL frequency resources and the DL frequency resources with a guard band may help to reduce self-interference. UL resources and a DL resources that are immediately adjacent to each other correspond to a guard band width of 0. As an output signal, e.g., from a UE transmitter, may extend outside the UL resources, the guard band may reduce interference experienced by the UE. The SBFD may also be referred to as “flexible duplex.”

The second example 510 and the third example 520 illustrates the IBFD resources. In the IBFD, signals may be transmitted and received in overlapping times and at least partially overlapping in frequency (overlapping in the time domain and the frequency domain). As shown in the second example 510, a time and a frequency allocation of a UL resources 512 may overlap with at least a part of a time and a frequency allocation of DL resources 514. In the third example 520, a time and a frequency allocation of UL resources 522 and a time and a frequency of allocation of DL resources 524 may fully overlap with each other. Particularly, the third example 520 may be referred to as single-frequency FD (SFFD).

In some aspects, an FD base station (e.g., the first base station 402a and 402b) may serve a plurality of UEs including UEs with different duplexing schemes or capabilities of HD and FD. That is, the FD base station may serve a plurality of UEs, where the plurality of UEs may include at least one HD UE and at least one FD UE.

In one aspect, the HD UE may include a legacy HD or an FD-aware HD UE. The legacy HD UE may refer to the UEs that are not aware that the FD base station may provide the FD operation in TDD band. That is, the legacy HD UE may not be aware of any operation related to the FD mode performed by the FD base station. The FD-aware HD UE may refer to the UEs that are operating, or may support operating, in the HD mode but aware of the FD base station. The FD-aware HD UE may support certain enhancement to enable the FD base station. For example, FD-aware HD UE may receive information of UL/DL sub-bands, support scheduling enhancements such as an FD dependent UL/DL sub-bands configuration.

In another aspect, the FD UEs may be capable to operate in different modes of the UL/DL sub-bands. In one example (e.g., Mode1), the FD UE may operate with the UL/DL sub-bands non-overlapping each other (e.g., the first example 500 of the SBFD). In another example (e.g., Mode2), the FD UE may operate with the UL/DL sub-bands partially overlapping each other (e.g., the second example 510 of the IBFD). In another example, (e.g., Mode3), the FD UE may operate with the UL/DL sub-bands fully overlapping each other (e.g., the third example 520 of the SFFD).

During the initial access procedure (e.g., the RACH procedure), the indication of UE's FD capability, including the FD-aware HD UE or the FD UE in one of the first mode, the second mode, or the third mode, may be transmitted to the network node, and the FD network node may fully leverage the UE's FD capability based on the indication. That is, if the UE with the FD capability may indicate the UE's FD capability to the network node in the early stage of the wireless communication (e.g., the initial access procedure), the network node may improve the efficiency in allocating the wireless communication resources for the UE based on the FD capability of the UE as indicated.

In some aspects, the indication of the UE's FD capability may be indicated in an implicit manner. That is, the UE may be configured to indicate the UE's FD capability based on one or more characteristics of the RACH message transmitted during the initial access procedure to the network node, and the network node may obtain the indication of the UE's FD capability based on the one or more characteristics of the RACH resource the UE may use or RACH message received from the UE during the initial access procedure.

In one aspect, the network node may configure multiple (or separate) RACH resource configurations for different UEs with based on their FD capabilities. That is, the UE may be configured to select the SSB or CSI-RS and the associated RO based on its FD capability. Here, the indication of the FD capability of the UE may indicate one of the following capability of the UE: (i) the UE is in a half-duplex (HD) mode and has awareness of the FD mode (e.g., the FD-aware HD UE), (ii) the UE is in the FD mode configured with non-overlapping uplink (UL)/downlink (DL) sub-bands (e.g., the FD UE in the Mode1), (iii) the UE is in the FD mode configured with partially overlapping UL/DL sub-bands (e.g., the FD UE in the Mode2), or (iv) the UE is in the FD mode configured with fully overlapping UL/DL sub-bands (e.g., the FD UE in the Mode3).

The network node may configure separate RACH resource configurations (e.g., different RACH preambles or RACH occasions (ROs)) for UEs with different FD capabilities, and the network may configure separate RACH preamble or separate ROs for the FD-aware HD UE, the FD UE in the Mode1, the FD UE in the Mode2, of the FD UE in the Mode3, and each UE may transmit the RACH message (e.g., message 1 (Msg1), message 3 (Msg3), or message A (MsgA)) to the network node using the separate RACH preamble and/or RO associated with the FD capability of the UE. That is, the FD-aware HD UE or FD UE may select the RACH preamble or the RO dedicated for FD purposes to transmit the RACH message to the network node. The network may receive the RACH message from the UE, and based on the RACH preamble or the RO selected by the UE to transmit the RACH message to the network node, may obtain the FD capability of the UE implied by the at least one configuration of the RACH resource (i.e., the RACH preamble or the separate RO) configurations of the RACH message received from the UE. The at least one RACH resource configuration may include separate ROs and/or a preamble partitioning.

In one example, the network node may configure multiple RACH preambles but not separate ROs, the FD capable UE may indicate its capability using the preamble. In another example, the network node may configure separate ROs for the FD capable UE to indicate its capability through ROs and/or dedicated preamble. In another example, the network may configure multiple RACH preambles and the separate ROs, and the UE may use a combination of the multiple RACH preambles and the separate ROs. That is, the UE may determine whether a UE is an FD-aware HD UE or an FD UE, and use the RACH preamble to indicate the FD mode of the UE. For example, in the first example 600, a UE that is an FD UE in Mode3 may select RO resource 612 to transmit the RACH message to the network node, and select the RACH preamble associated with the Mode3. Therefore, the UE may transmit the RACH message including the RACH preamble associated with the Mode3 in the RO associated with Mode3, and the network node may identify that the UE is the FD UE in Mode3 based on RO in which the UE transmitted the RACH message including the RACH preamble associated with the Mode3.

In one aspect, the at least one RACH resource configuration may include separate ROs. To initiate the RACH procedure, the UE may measure plurality of downlink reference signals (e.g., SSB or CSI-RS) and identify a set of downlink reference signals that may have corresponding metrics greater than or equal to a threshold value. From the set of downlink reference signals, the UE may select a first RACH resource (e.g., RO or RACH preamble) associated with a first downlink reference signal from the set of downlink reference signal, and communicate (or transmit) the RACH message to the network node using the RACH resource (e.g., transmitted in the RO corresponding to the RACH resource or transmitting the RACH preamble corresponding to the RACH resource).

The at least one RACH resource configuration may include a plurality of sets of ROs, and the network node may configure the plurality of sets of ROs to include each set of ROs associated with different FD capabilities of the UE. In one example, the network node may allocate a first set of RO associated with legacy HD UE. The first set of RO may be allocated not to overlap with the plurality of downlink reference signals (e.g., SSBs) in time domain. The legacy HD UE may not transmit the UL signal and receive the DL signal simultaneously in time, and the legacy HD UE may determine any RO overlapping with the plurality of downlink reference signals in time domain as an invalid RO. Accordingly, the first set of ROs not overlapping with the plurality of downlink reference signals in time domain may be allocated for the legacy HD UE. On the other hand, the integrated subframe including at least one downlink reference signal and at least one RO allocated overlapping in time may be configured for the FD-aware HD UE or the FD UE.

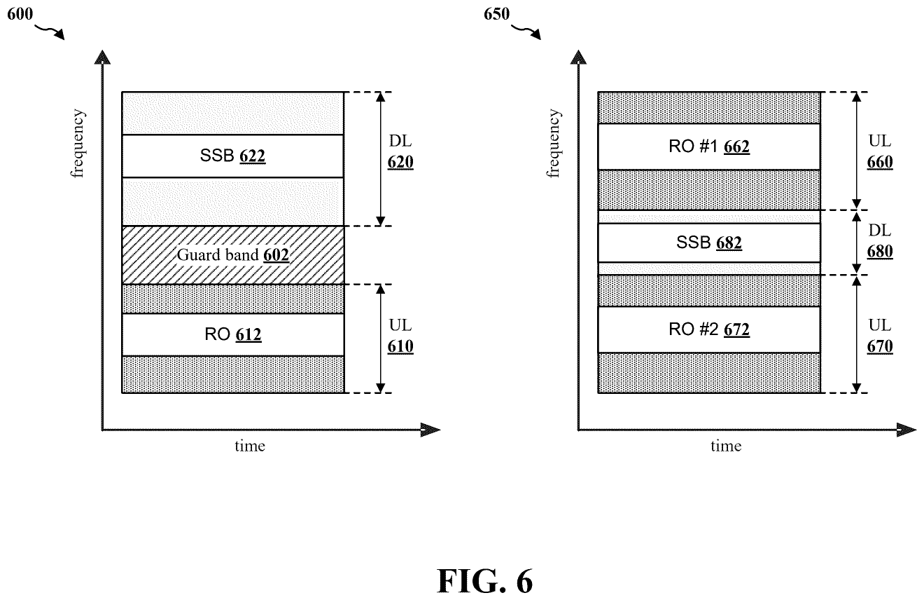

FIG. 6 illustrates examples of integrated subframe of wireless communication. The first example 600 of the integrated subframe may be SBFD resources including a UL resource 610, a DL resource 620, and a guard band 602 (e.g., integrated SSB/RO subframe). When FD is configured by network, SSB and RO could be overlapped in time domain. For the plurality of UEs in FD system, the SSB and the RO may share the same time resources but in different frequency resources. That is, the one or more ROs may overlap with the SSB. The legacy UE may not use the RO resources in the integrated SSB/RO subframe.

The network node may configure the SSB resource 622 and/or the RO resource 612 commonly for the FD-aware HD UE or the FD UE. The UE selecting the integrated SSB/RO subframe to perform the RACH may implicitly indicate the FD-aware HD UE or the FD capability of the FD capable UE. The UL resource 610 may include an RO resource 612 and the DL resource 620 may include an SSB resource 622. The SSB resource 622 and the RO resource 612 may overlap with each other in the time domain. The HD UE without the FD capability may not select the SSB resource 622 or an SSB associated with the RO resource 612 to transmit the RACH message to the network node. The FD-aware HD UE or the FD UE may select the SSB resource 622 and transmit the RACH message to the network node in the RO associated with the SSB resource 622, or may select the SSB associated with the RO resource 612 to transmit the RACH message to the network node. Accordingly, the network node may determine that the UE is one of the FD-aware HD UE or the FD UE based on receiving the RACH message from the UE in the RO associated with the SSB resource 622 or the RO resource 612.

In another aspect, the FD-aware HD UE or the FD capable UE with different capabilities may be configured to select different ROs with different association with the plurality of SSBs. The second example 650 of the integrated subframe may be SBFD resources including a first UL resource 660, a second UL resource 670, and a DL resource 680. The first UL resource 660 may include a first RO resource 662, the second UL resource 670 may include a second RO resource 672, and the DL resource 680 may include an SSB resource 682. The SSB resource 682 may be configured to correspond to a third RO. Here, the network node may associate at least one of the first RO resource 662, the second RO resource 672, or the third RO with different FD capabilities of the plurality of UEs. Each UE of the plurality of UEs may measure the plurality of SSBs including the SSB resource 682, identify the qualifying downlink reference signals (e.g., qualifying SSBs), and select the SSB corresponding with the RO associated with the FD capability of the UE.

For example, the network node may associate the first RO resource 662 with the FD-aware HD UE, the second RO resource 672 with the FD UE in Mode 1, and the third RO with the FD UE in Mode 2. A UE that is the FD UE in Mode 2 may measure the plurality of SSBs including the SSB resource 682, identify the qualifying SSBs, and the UE may select the SSB resource 682 to perform the RACH procedure. The UE may use the RACH configuration from the SSB resource 682 and transmit the RACH message in the RO associated with the SSB resource 682. The network may receive the RACH message from the UE in the RO associated with the FD UE in Mode2, and determine that the UE is an FD UE in Mode2 based on receiving the RACH message from the UE in the RO associated with the FD UE in Mode2.

In some aspects, the network node may configure different RACH preambles for UEs with different FD capabilities. The UE may use the RACH preamble associated with the FD capability of the UE to indicate the FD capability of the UE. In one example, the network node may configure RACH preamble partitioning to configure multiple RACH preambles for the UEs with different FD capabilities.

During the RACH procedure, the UE may obtain at least one preamble (e.g., primary advanced (PA)-preamble or secondary advanced (SA)-preamble), and transmit the RACH message including the RACH preamble to the network node based on the preamble configured by network. Here, the preamble may refer to a sequence of code used to facilitate network synchronization. The network node may partition the preamble into a number of non-overlapping subsets, and configure partitioning information of the preamble. The UE may generate the RACH preamble based on the number of non-overlapping subsets of the preamble and the partitioning information of the preamble, and transmit the generated RACH preamble to the network. The network may associate the FD capability of the UE with the partitioning information of the preamble, and the UE may select the partitioning information based on the FD capability of the UE. The network may receive the RACH message including the RACH preamble generated based on the number of non-overlapping subsets of the preamble and the partitioning information of the preamble from the UE, and identify the FD capability of the UE based on the partitioning information that the UE based the RACH preamble.

Based on the RACH partitioning, the UE may obtain a set of RACH preambles associated with capabilities of the UE. The set of RACH preambles may include at least one of a first subset of RACH preambles associated with a first UE capability of being in an HD mode and having awareness of the FD mode; a second subset of RACH preambles associated with a second UE capability of being in the FD mode configured with non-overlapping UL/DL sub-bands; a third subset of RACH preambles associated with a third UE capability of being in the FD mode configured with partially overlapping UL/DL sub-bands; or a fourth subset of RACH preambles associated with a fourth UE capability of being in the FD mode configured with fully overlapping UL/DL sub-bands. Here, the set of RACH resources may include a set of RACH preambles associated with the FD capability of the UE.

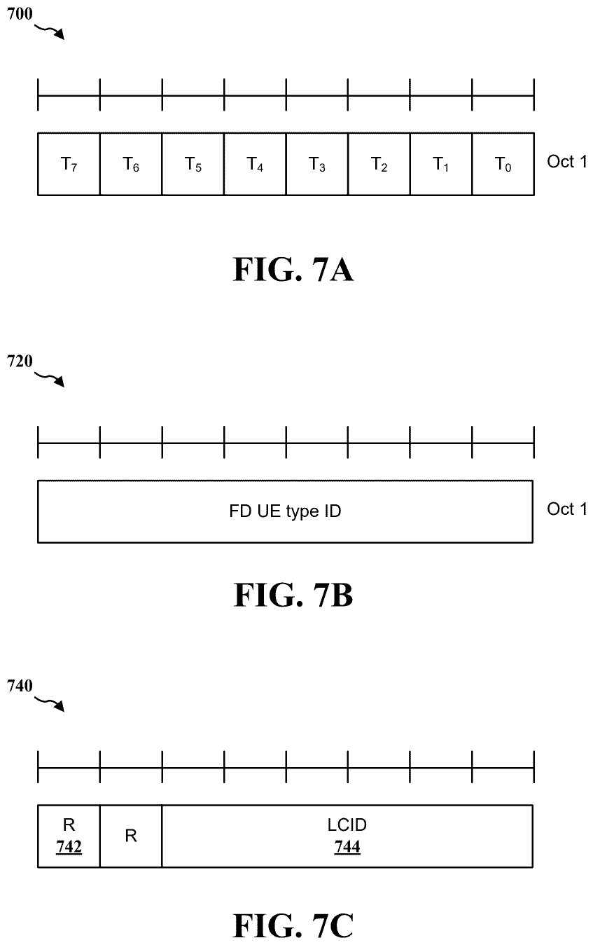

FIGS. 7A, 7B, and 7C illustrate examples 700, 720, and 740, respectively, of indication of UE capabilities. In some aspects, the UE may transmit a message indicating the FD capability of the UE. The message indicating the FD capability may include dedicated a medium access control (MAC) control element (CE) (MAC-CE) or a dedicated RRC message. The dedicated MAC-CE or the dedicated RRC message may be transmitted in a RACH message (e.g., Msg3 or MsgA) to the network node.

FIGS. 7A and 7B illustrate a first example 700 and a second example 720 of dedicated MAC-CE that may be sent in the Msg3 or the MsgA to explicitly indicate the FD-aware HD UE or FD UE capabilities. The first example 700 of the MAC-CE and the second example 720 of the MAC-CE may be one-byte MAC-CE to indicate the FD capability of the UE, and the first example 700 may include a bitmap and the second example 720 may include the identifier (ID) of the FD capability of the UE.

The bitmap in the first example 700 of the MAC-CE or the FD capability ID in the second example 720 of the MAC-CE may indicate one of the following capability of the UE: (i) the UE is in a half-duplex (HD) mode and has awareness of the FD mode (e.g., the FD-aware HD UE), (ii) the UE is in the FD mode configured with non-overlapping uplink (UL)/downlink (DL) sub-bands (e.g., the FD UE in the Mode1), (iii) the UE is in the FD mode configured with partially overlapping UL/DL sub-bands (e.g., the FD UE in the Mode2), or (iv) the UE is in the FD mode configured with fully overlapping UL/DL sub-bands (e.g., the FD UE in the Mode3).

In one aspect, the first example 700 of the MAC-CE may include a bitmap indicating the FD capability of the UE. In one example, each bit field of the bitmap may indicate whether the UE supports each of the FD-aware HD UE, or FD operation in the Mode1, the Mode2, or the Mode3. For example, the UE may transmit the first example 700 of the MAC-CE including a bitmap of 00000110 to indicate that the UE may support the FD operation in the Mode1 and the Mode2. The bitmap may indicate one or multiple capabilities that the UE may support. The UE may transmit the first example 700 of the MAC-CE including the bitmap to the network node to indicate the FD capability of the UE.

In another aspect, the second example 720 of the MAC-CE may include an FD capability ID indicating the FD capability of the UE. The FD capability ID may indicate that the UE is one of the FD-aware HD UE or the FD UE in one of the Mode1, the Mode2, or the Mode3. The UE may transmit the second example 720 of the MAC-CE including the FD capability ID to the network node to indicate the FD capability of the UE.

The first example 700 and the second example 720 of the MAC-CE may use at least one of the bit fields to indicate other specifications of the FD operation, such as minimum frequency separation between the UL/DL sub-bands for SBFD, max overlapping BW between the UL/DL sub-bands, maximum transmit power, maximum timing advance, etc., to enable the FD operation of the UE. Furthermore, at least one of the bit fields of the first example 700 and the second example 720 of the MAC-CE may be used to indicate other capabilities of the UE or features supported by the UE. For example, at least one of the bit fields of the first example 700 and the second example 720 of the MAC-CE may indicate that the UE may have a capability to support at least one of a coverage enhancement in one network slicing, working for network slicing, small data transmission (SDT), or that the UE may have a reduced capability or that the UE may have at least one process relaxed.

In another aspect, the message indicating the FD capability may include the dedicated RRC message. Here, the RRC message may include a bitmap similar to the bitmap of the first example 700 or an FD capability ID similar to the FD capability ID in the second example 720 to indicate the FD capability of the UE. The bitmap or the FD capability ID in the RRC message may indicate one of the following capability of the UE: (i) the UE is in a half-duplex (HD) mode and has awareness of the FD mode (e.g., the FD-aware HD UE), (ii) the UE is in the FD mode configured with non-overlapping uplink (UL)/downlink (DL) sub-bands (e.g., the FD UE in the Mode1), (iii) the UE is in the FD mode configured with partially overlapping UL/DL sub-bands (e.g., the FD UE in the Mode2), or (iv) the UE is in the FD mode configured with fully overlapping UL/DL sub-bands (e.g., the FD UE in the Mode3). The bitmap or the FD capability ID in the RRC message may include at least one of other specifications of the FD operation or indication other capabilities of the UE or features supported by the UE.

In another aspect, the UE may use a dedicated MAC subheader including a reserved bit-field or a logical channel identifier (LCID) to indicate the FD capability of the UE. FIG. 7C illustrates the third example 740 of the dedicated MAC subheader of the MAC PDU including the reserved bit-field 742 and the LCID 744. Any MAC PDU sent via the Msg3 or the MsgA PUSCH may be used to indicate the FD capability of the UE. For example, the dedicated subheader of the MAC PDU of the third example 740 may be a subheader for a common control channel (CCCH) message transmitted in the Msg3 or MsgA (e.g., PUSCH) during the RACH procedure. The dedicated MAC subheader may include a new or separate dedicated LCID to indicate the FD capability of the UE.

In one example, the UE may use a dedicated LCID value of a subheader of a MAC PDU transmitted in the PUSCH of the Msg1 or MsgA during the RACH procedure. For example, the UE may use the LCID value of a subheader for the CCCH message to specify that the UE is the FD-aware HD UE or the FD UE. That is, the UE that is one of the FD-aware HD UE or the FD UE may indicate that the UE is the FD-aware HD UE or the FD UE supporting operation in one of the Mode1, the Mode2, or the Mode3 using the corresponding LCID value in the CCCH message. The FD-aware HD UE or the FD UE may send the CCCH message (in the PUSCH of the Msg3 or the MsgA) with the value of the LCID specified for the FD-aware HD UE or the FD UE during performing the RACH procedure to indicate the FD capability of the UE, and the network node may identify the UE capability of the UE based on the value of the LCID of the subheader of a MAC PDU (e.g., the CCCH message). Multiple values of the LCID may be configured, and for example, four dedicated LCID value may be assigned or defined to indicate the four different FD capabilities of the FD-aware HD UE or the FD UE supporting operation in one of the Mode1, the Mode2, or the Mode3. In another example, the UE may use one of the reserved bit-field of the subheader of a MAC PDU transmitted in the PUSCH of the Msg1 or MsgA during the RACH procedure. For example, when the subheader of the CCCH message has a R/R/LCID structure, the UE may use the first reserved bit-field to indicate whether the UE is one of the FD-aware HD UE or FD capable UE or the UE is the legacy HD UE.

In some aspects, the network node may configure at least one dedicated demodulation reference signal (DMRS) resource configuration associated with the Msg3 or the MsgA (e.g., PUSCH). The DMRS is included in the PUSCH for the network node to estimate the UL channel using the DMRS. The DMRS may have various configurations, such as the pattern of the DMRS resources. That is, the network node may configure a dedicated DMRS resource common for the FD-aware HD UE and the FD UE, or configure a plurality of DMRS resources, each of DMRS resource of the plurality of DMRS resources being associated with one of the FD-aware HD UE, or the FD UE supporting operation in the Mode1, the Mode2, or the Mode3.

The configuration of the dedicated DMRS resource may be specifically configured for the FD-aware HD UE or the FD UE with different capabilities. In one example, the network node may indicate a first DMRS configuration (e.g., dmrs-UplinkForPUSCH-MappingTypeA) for legacy HD UE and a second DMRS configuration for the FD-aware HD UE or the FD UE (e.g., dmrs-UplinkForPUSCH-MappingTypeB). In another example, the network node may provide dedicated DMRS configurations (e.g., MsgA-DMRS-Config under MsgA-PUSCH-Resource configuration) for different FD capabilities of the UE including the FD-aware HD UE or the FD UE supporting operation in the Mode1, the Mode2, or the Mode3.

The UE may include the dedicated DMRS resource in the PUSCH transmitted in the Msg3 or MsgA based on the FD capability of the UE, and the FD-aware HD UE or the FD UE may use the dedicated DMRS resource in the PUSCH transmission in Msg3 or MsgA as configured by the network node. The dedicated DMRS resource may serve as an early indication to inform the network node of the FD capability of the UE. On the other hand, the legacy UE may not be configured with the dedicated DMRS resource or may not be allowed to use the dedicated DMRS resource when transmitting the PUSCH of the Msg3 or the MsgA.

In some aspects, more than one of the above implementation of indicating the FD capability of the UE may be combined to indicate the FD capability. That is, the UE may indicate that the UE is one of the FD-aware HD UE or the FD UE using at least one or a combination of (i) RACH configuration including at least one of the RACH preamble or the RO associated with the FD capabilities, (ii) a configuration of the DMRS transmitted in the PUSCH of the MsgA or the Msg3 associated with the FD capabilities, or (iii) a configuration of the dedicated RRC message or the dedicated MAC-CE for transmitting the FD capabilities.

For example, an FD UE operating in Mode1 may include non-overlapping UL/DL sub-band, and may select the specific RO (for FD purposes) in the integrated SSB/RO subframe and use the common PRACH preamble. In another example, the UE may use the dedicated DMRS resource and indicate its FD capability (i.e., Msg1-non-overlapping UL/DL sub-band mode) by using the dedicated LCID value for the CCCH message in the MsgA or the Msg3.

In some aspects, the UE may transmit an early indication of the UE's capability during the RACH procedure, and the network node may configure one or more resources for the UE based on the received indication of the FD capability of the UE. In one aspect, the network node may perform other features that may be associated with the FD capability of the UE based on receiving the early indication of the UE's FD capability. In another aspect, the MAC-CE bitmap field (e.g., the first example 700, the second example 720, or the third example 740) may be extended with more bits to indicate the combination of the FD capability of the UE with at least one different capabilities or other features supported by the UE.

In one example, based on the early indication of the FD capability of the UE, the network node may identify that the UE may have a capability to support at least one of a coverage enhancement in one network slicing. In another example, based on the early indication of the FD capability of the UE, the network node may identify that the UE may support the network slicing. In another example, based on the early indication of the FD capability of the UE, the network node may identify that the UE may support the SDT. In another example, based on the early indication of the FD capability of the UE, the network node may identify that the UE may have a reduced capability. In another example, based on the early indication of the FD capability of the UE, the network node may identify that that the UE may have at least one process relaxed.

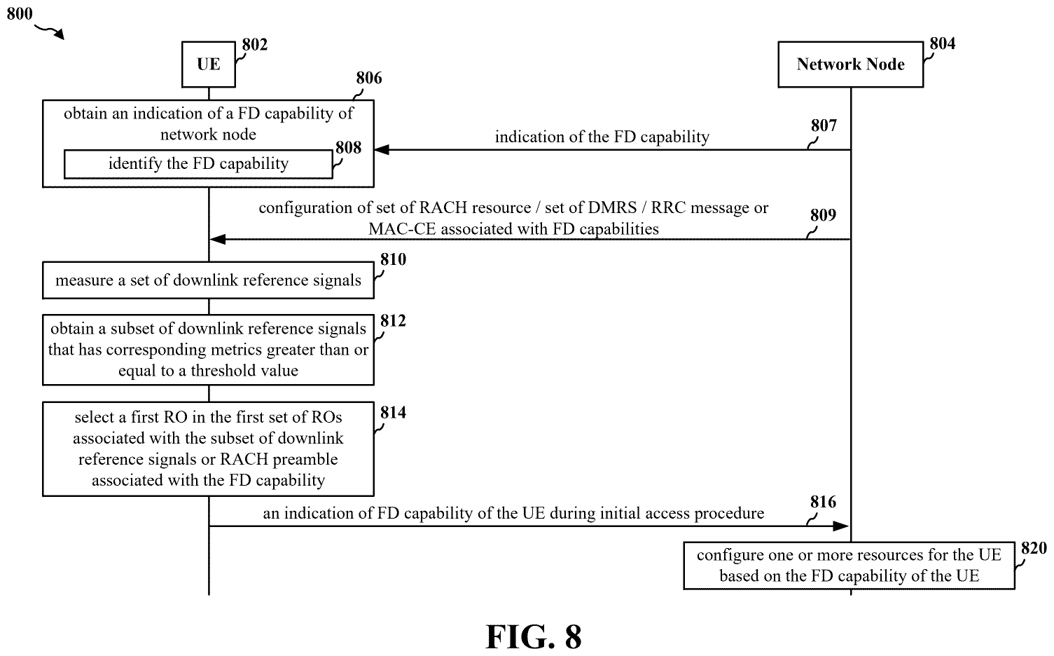

FIG. 8 is a call-flow diagram 800 of wireless communication. The call-flow diagram 800 may include a UE 802 and a network node 804. The UE 802 may transmit an early indication of the FD capability of the UE 802 to the network node 804 during the initial access procedure (e.g., RACH procedure), and the network node 804 may receive the early indication of the FD capability to improve the efficiency in resource allocation based on the FD capability of the UE 802. The UE 802 may obtain an indication of an FD capability of a network node 804, the indication of the FD capability of the network node 804 indicating that the network node 804 supports an FD mode, and transmit, during an initial access procedure, an indication of an FD capability of the UE 802 to the network node 804. The network node 804 may receive the indication of the FD capability of the UE 802, and configure one or more resources for the UE 802 based on the received FD capability of the UE 802.

The UE 802 may have at least one of the following FD capabilities: (i) the UE being in a half-duplex (HD) mode and having awareness of the FD mode (e.g., FD-aware HD UE), (ii) the UE being in the FD mode configured with non-overlapping UL/DL sub-bands (e.g., FD UE operating in Mode1), (iii) the UE being in the FD mode configured with partially overlapping UL/DL sub-bands (e.g., FD UE operating in Mode2), or (iv) the UE being in the FD mode configured with fully overlapping UL/DL sub-bands (e.g., FD UE operating in Mode3).

At 806, the UE 802 may obtain an indication of an FD capability of a network node 804, the indication of the FD capability of the network node 804 indicating that the network node 804 supports an FD mode. In some aspects, 806 may include 807 and 808.

At 807, the network node 804 may transmit an indication of an FD capability of the network node 804 to the UE 802, and the indication of the FD capability of the network node 804 may indicate that the network node 804 may support an FD mode. The UE 802 may receive the indication of the FD capability of the network node 804 from the network node 804. The UE 802 may obtain the indication of the FD capability of the network node 804 based on the indication received from the network node 804.

At 808, the UE 802 may identify the FD capability of the network node 804. That is, the UE 802 may infer the FD capability of the network node 804 from at least one configuration of related features or capabilities of the network node 804.

In one aspect, the indication of the FD capability of the UE 802 may be associated with a set of RACH resources used for the initial access procedure. That is, the indication of the UE's FD capability may be indicated in an implicit manner, and the UE 802 may be configured to indicate the UE's FD capability based on one or more characteristics of the RACH message transmitted during the initial access procedure to the network node 804. The network may obtain the indication of the UE's FD capability based on the one or more characteristics of the RACH message received from the UE 802 during the initial access procedure.

In another aspect, the network node 804 may configure multiple (or separate) RACH resource configurations for different UEs with based on their FD capabilities. That is, the UE 802 may be configured to select the SSB or CSI-RS and the associated RO based on its FD capability. Here, the indication of the FD capability of the UE 802 may indicate one of the following capability of the UE 802: (i) the UE 802 is in an HD mode and has awareness of the FD mode (e.g., the FD-aware HD UE), (ii) the UE 802 is in the FD mode configured with non-overlapping UL/DL sub-bands (e.g., the FD UE in the Mode1), (iii) the UE 802 is in the FD mode configured with partially overlapping UL/DL sub-bands (e.g., the FD UE in the Mode2), or (iv) the UE 802 is in the FD mode configured with fully overlapping UL/DL sub-bands (e.g., the FD UE in the Mode3).

The network node 804 may configure separate RACH resource configurations (e.g., different RACH preambles or RACH occasions (ROs)) for UEs with different FD capabilities, and the network may configure separate RACH resource or separate ROs, and each UE 802 may transmit the RACH message (e.g., Msg1, Msg3, or MsgA) to the network node 804 using the RO associated with the FD capability of the UE 802.

At 809, the network node 804 may configure the UE 802 with at least one configuration of a set of RACH resource, a set of DMRS, or an RRC message/MAC-CE associated with FD capabilities. The UE 802 may receive at least one configuration of a set of RACH resource, a set of DMRS, or an RRC message/MAC-CE associated with FD capabilities. In one example, the set of RACH resources may include a plurality of RACH preambles associated with FD capabilities of the UE 802. In another example, the set of RACH resources may include a plurality of sets of ROs associated with FD capabilities of the UE 802. In another example, the set of DMRS transmitted in the PUSCH of the MsgA or the Msg3 may be configured to indicate the FD capabilities of the UE 802. In another aspect, the dedicated RRC message or the dedicated MAC-CE may be configured to transmit the FD capabilities of the UE 802.

At 810, the UE 802 may measure a set of downlink reference signals (e.g., the SSB/CSI-RS) received from the network node 804. The set of downlink reference signals may be associated with the set of RACH resources that may include a plurality of sets of ROs including a first set of ROs, each RO of the first set of ROs overlapping at least in part with a downlink reference signal of the set of downlink reference signals in a time domain. The first set of ROs may include at least one of a first subset of ROs associated with a first UE capability of being in an HD mode and having awareness of the FD mode; a second subset of ROs associated with a second UE capability of being in the FD mode configured with non-overlapping UL/DL sub-bands; a third subset of ROs associated with a third UE capability of being in the FD mode configured with partially overlapping UL/DL sub-bands; or a fourth subset of ROs associated with a fourth UE capability of being in the FD mode configured with fully overlapping UL/DL sub-bands. Here, the set of RACH resources may include a plurality of sets of ROs, where a first set of ROs of the plurality of sets of ROs is associated with the FD capability of the UE 802.

At 812, the UE 802 may obtain a subset of downlink reference signals from the set of downlink reference signals, the subset of downlink reference signals having one or more metrics greater than or equal to a threshold value. The subset of downlink reference signals (e.g., the SSB/CSI-RS) having one or more metrics greater than or equal to the threshold value, and each downlink reference signal of the subset of downlink reference signals may have the metric that is better than a threshold value that the UE 802 may use for the initial access procedure.

At 814, the UE 802 may select a first RO in the first set of ROs associated with the subset of downlink reference signals or a first RACH preamble associated with the FD capability. In one example, the UE 802 may select the first RO from the first set of ROs associated with the subset of downlink reference signals obtained at 812 based on the FD capability of the UE 802. In another example, the UE 802 may select a first RACH preamble associated with the FD capability of the UE 802 to be transmitted in the Msg3 or MsgA.

At 816, the UE 802 may transmit, during an initial access procedure, an indication of an FD capability of the UE 802 to the network node 804. The network node 804 may obtain, during an initial access procedure, an indication of the FD capability of the UE 802. Here, the indication of the FD capability of the UE 802 may indicate one of: (i) the UE being in an HD mode and having awareness of the FD mode, (ii) the UE being in the FD mode configured with non-overlapping UL/DL sub-bands, (iii) the UE being in the FD mode configured with partially overlapping UL/DL sub-bands, or (iv) the UE being in the FD mode configured with fully overlapping UL/DL sub-bands.

In one aspect, the indication of the FD capability of the UE 802 may be associated with a set of RACH resources used for the initial access procedure as selected at 814. The set of RACH resources may include a plurality of ROs or a plurality of RACH preambles. The network may configure separate RACH resource configurations (e.g., different RACH preambles or RACH occasions (ROs)) for UEs with different FD capabilities at 809.

In one example, the at least one RACH resource configuration may include the first RO. To transmit the indication of the FD capability of the UE 802, the UE 802 may be configured to transmit a RACH message in the first RO selected at 814 associated with the FD capability of the UE 802.

In another example, the at least one RACH resource configuration may include a preamble partitioning. To transmit the indication of the FD capability of the UE, the UE 802 may transmit a RACH message including the first RACH preamble selected at 814 to the network node. Based on the preamble transmitted to the network node 804, and the network node 804 may identify the FD capability of the UE 802 based on the preamble received in the Msg3 or the MsgA.

In another aspect, the indication of the FD capability of the UE 802 may be transmitted in one of the Msg3 or the MsgA. Here, the indication of the FD capability of the UE 802 may be transmitted in a MAC-CE or an RRC message. In one example, the MAC-CE may include the indication of the FD capability of the UE 802. For example, the MAC-CE may be one-byte MAC-CE to indicate the FD capability of the UE 802, and the MAC-CE may include a bitmap or the ID of the FD capability of the UE 802. Here, each bit field of the bitmap may indicate whether the UE 802 supports each of the FD-aware HD UE, or FD operation in the Mode1, the Mode2, or the Mode3. The UE 802 may use at least one of the bit fields of the MAC-CE to indicate other specifications of the FD operation, such as minimum frequency separation between the UL/DL sub-bands for SBFD, max overlapping BW between the UL/DL sub-bands, maximum transmit power, maximum timing advance, etc., to enable the FD operation of the UE 802. The MAC-CE may also be used to indicate other capabilities of the UE 802 or features supported by the UE 802. For example, at least one of the bit fields of the MAC-CE may indicate that the UE 802 may have a capability to support at least one of a coverage enhancement in one network slicing, working for network slicing, SDT, or that the UE 802 may have a reduced capability or that the UE 802 may have at least one process relaxed.

In another example, the RRC message may include the indication of the FD capability of the UE 802. The RRC message may include a bitmap or an FD capability ID to indicate the FD capability of the UE 802. The bitmap or the FD capability ID in the RRC message may include at least one of other specifications of the FD operation or indication other capabilities of the UE 802 or features supported by the UE 802.

In another example, the indication of the FD capability may be transmitted in a dedicated medium access control (MAC) subheader of a MAC PDU for a RRC message. That is, the UE 802 may use a dedicated LCID value of a subheader of a MAC PDU transmitted in the PUSCH of the Msg1 or MsgA during the RACH procedure. For example, the UE 802 may use the LCID value of a subheader for the CCCH message to specify that the UE 802 is the FD-aware HD UE or the FD UE 802.

In another example, the indication of the FD capability may be transmitted in a reserved bit of a MAC subheader used for early indication. For example, when the subheader of the CCCH message has a R/R/LCID structure, the UE 802 may use the first reserved bit-field to indicate whether the UE 802 is one of the FD-aware HD UE or FD capable UE or the UE 802 is the legacy HD UE.

In another aspect, the indication of the FD capability of the UE 802 may be associated with a DMRS of one of a Msg3 or a MsgA. The network node 804 may configure, at 809, a dedicated DMRS resource common for the FD-aware HD UE and the FD UE 802, or configure a plurality of DMRS resources, each of DMRS resource of the plurality of DMRS resources being associated with one of the FD-aware HD UE, or the FD UE 802 supporting operation in the Mode1, the Mode2, or the Mode3. The UE 802 may include the dedicated DMRS resource in the PUSCH transmitted in the Msg3 or MsgA based on the FD capability of the UE 802, and the network node 804 may identify the FD capability of the UE 802 based on the DMRS resource included in the PUSCH received in the Msg3 or MsgA.

At 820, the network node 804 may configure one or more resources for the UE 802 based on the FD capability of the UE 802. The UE 802 may transmit an early indication of the UE's capability during the RACH procedure, and the network node 804 may configure one or more resources for the UE 802 based on the received indication of the FD capability of the UE 802.

In one example, based on the early indication of the FD capability of the UE 802, the network node 804 may identify that the UE 802 may have a capability to support at least one of a coverage enhancement in one network slicing. In another example, based on the early indication of the FD capability of the UE 802, the network node 804 may identify that the UE 802 may support the network slicing. In another example, based on the early indication of the FD capability of the UE 802, the network node 804 may identify that the UE 802 may support the SDT. In another example, based on the early indication of the FD capability of the UE 802, the network node 804 may identify that the UE 802 may have a reduced capability. In another example, based on the early indication of the FD capability of the UE 802, the network node 804 may identify that that the UE 802 may have at least one process relaxed.

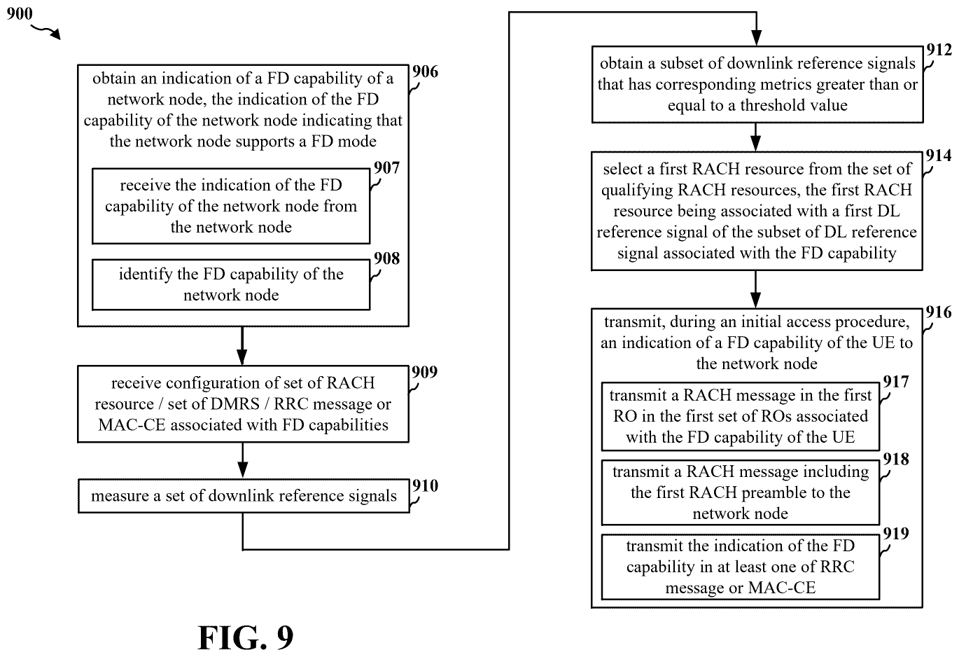

FIG. 9 is a flowchart 900 of a method of wireless communication. The method may be performed by a UE (e.g., the UE 104/802; the apparatus 1304). The UE may transmit an early indication of the FD capability of the UE to a network node during the initial access procedure (e.g., RACH procedure), and the network node may receive the early indication of the FD capability to improve the efficiency in resource allocation based on the FD capability of the UE. The UE may obtain an indication of an FD capability of a network node, the indication of the FD capability of the network node indicating that the network node supports an FD mode, and transmit, during an initial access procedure, an indication of an FD capability of the UE to the network node. The network node may receive the indication of the FD capability of the UE, and configure one or more resources for the UE based on the received FD capability of the UE.

The UE may have at least one of the following FD capabilities: (i) the UE being in a half-duplex (HD) mode and having awareness of the FD mode (e.g., FD-aware HD UE), (ii) the UE being in the FD mode configured with non-overlapping UL/DL sub-bands (e.g., FD UE operating in Mode1), (iii) the UE being in the FD mode configured with partially overlapping UL/DL sub-bands (e.g., FD UE operating in Mode2), or (iv) the UE being in the FD mode configured with fully overlapping UL/DL sub-bands (e.g., FD UE operating in Mode3).

At 906, the UE may obtain an indication of an FD capability of a network node, the indication of the FD capability of the network node indicating that the network node supports an FD mode. For example, at 806, the UE 802 may obtain an indication of an FD capability of a network node 804, the indication of the FD capability of the network node 804 indicating that the network node 804 supports an FD mode. Furthermore, 906 may be performed by an early FD capacity indicating component 198. In some aspects, 906 may include 907 and 908.

At 907, the UE may receive the indication of the FD capability of the network node from the network node. The UE may obtain the indication of the FD capability of the network node based on the indication received from the network node. For example, at 807, the UE 802 may receive the indication of the FD capability of the network node 804 from the network node 804. Furthermore, 907 may be performed by the early FD capacity indicating component 198.

At 908, the UE may identify the FD capability of the network node. That is, the UE may infer the FD capability of the network node from at least one configuration of related features or capabilities of the network node. For example, at 808, the UE 802 may identify the FD capability of the network node 804. Furthermore, 908 may be performed by the early FD capacity indicating component 198.

In one aspect, the indication of the FD capability of the UE may be associated with a set of RACH resources used for the initial access procedure. That is, the indication of the UE's FD capability may be indicated in an implicit manner, and the UE may be configured to indicate the UE's FD capability based on one or more characteristics of the RACH message transmitted during the initial access procedure to the network node. The network may obtain the indication of the UE's FD capability based on the one or more characteristics of the RACH message received from the UE during the initial access procedure.

In another aspect, the network node may configure multiple (or separate) RACH resource configurations for different UEs with based on their FD capabilities. That is, the UE may be configured to select the SSB or CSI-RS and the associated RO based on its FD capability. Here, the indication of the FD capability of the UE may indicate one of the following capability of the UE: (i) the UE is in an HD mode and has awareness of the FD mode (e.g., the FD-aware HD UE), (ii) the UE is in the FD mode configured with non-overlapping UL/DL sub-bands (e.g., the FD UE in the Mode1), (iii) the UE is in the FD mode configured with partially overlapping UL/DL sub-bands (e.g., the FD UE in the Mode2), or (iv) the UE is in the FD mode configured with fully overlapping UL/DL sub-bands (e.g., the FD UE in the Mode3).

The network node may configure separate RACH resource configurations (e.g., different RACH preambles or RACH occasions (ROs)) for UEs with different FD capabilities, and the network may configure separate RACH resource or separate ROs, and each UE may transmit the RACH message (e.g., Msg1, Msg3, or MsgA) to the network node using the RO associated with the FD capability of the UE.

AT 909, the UE may receive at least one configuration of a set of RACH resource, a set of DMRS, or an RRC message/MAC-CE associated with FD capabilities. In one example, the set of RACH resources may include a plurality of RACH preambles associated with FD capabilities of the UE. In another example, the set of RACH resources may include a plurality of sets of ROs associated with FD capabilities of the UE. In another example, the set of DMRS transmitted in the PUSCH of the MsgA or the Msg3 may be configured to indicate the FD capabilities of the UE. In another aspect, the dedicated RRC message or the dedicated MAC-CE may be configured to transmit the FD capabilities of the UE.

At 910, the UE may measure a set of downlink reference signals (e.g., the SSB/CSI-RS) received from the network node. The set of downlink reference signals may be associated with the set of RACH resources that may include a plurality of sets of ROs including a first set of ROs, each RO of the first set of ROs overlapping at least in part with the downlink reference signal of the set of downlink reference signals in a time domain. The first set of ROs may include at least one of a first subset of ROs associated with a first UE capability of being in an HD mode and having awareness of the FD mode; a second subset of ROs associated with a second UE capability of being in the FD mode configured with non-overlapping UL/DL sub-bands; a third subset of ROs associated with a third UE capability of being in the FD mode configured with partially overlapping UL/DL sub-bands, or a fourth subset of ROs associated with a fourth UE capability of being in the FD mode configured with fully overlapping UL/DL sub-bands. Here, the set of RACH resources may include a plurality of sets of ROs, where a first set of ROs of the plurality of sets of ROs is associated with the FD capability of the UE. For example, at 810, the UE 802 may measure a set of downlink reference signals (e.g., the SSB/CSI-RS) received from the network node 804. Furthermore, 910 may be performed by the early FD capacity indicating component 198.

At 912, the UE may obtain a subset of downlink reference signals from the set of downlink reference signal, the subset of downlink reference signals having one or more metrics greater than or equal to a threshold value. The subset of downlink reference signals (e.g., the SSB/CSI-RS) having one or more metrics greater than or equal to the threshold value, and each downlink reference signal of the subset of downlink reference signals may have the metric that is better than a threshold value that the UE may use for the initial access procedure. For example, at 812, the UE 802 may obtain a subset of downlink reference signals from the set of downlink reference signals, the subset of downlink reference signals having one or more metrics greater than or equal to a threshold value. Furthermore, 912 may be performed by the early FD capacity indicating component 198.

At 914, the UE may select a first RO in the first set of ROs associated with the subset of downlink reference signals or a first RACH preamble associated with the FD capability. In one example, the UE may select the first RO from the first set of ROs associated with the subset of downlink reference signals obtained at 812 based on the FD capability of the UE. In another example, the UE 802 may select a first RACH preamble associated with the FD capability of the UE 802 to be transmitted in the Msg3 or MsgA. For example, at 814, the UE 802 may select a first RACH resource from the set of qualifying RACH resources, the first RACH resource being associated with the first RO in the first set of ROs associated with the FD capability. Furthermore, 914 may be performed by the early FD capacity indicating component 198.

At 916, the UE may transmit, during an initial access procedure, an indication of an FD capability of the UE to the network node. Here, the indication of the FD capability of the UE may indicate one of: (i) the UE being in an HD mode and having awareness of the FD mode, (ii) the UE being in the FD mode configured with non-overlapping UL/DL sub-bands, (iii) the UE being in the FD mode configured with partially overlapping UL/DL sub-bands, or (iv) the UE being in the FD mode configured with fully overlapping UL/DL sub-bands. For example, at 816, the UE 802 may transmit, during an initial access procedure, an indication of an FD capability of the UE 802 to the network node 804. Furthermore, 916 may be performed by the early FD capacity indicating component 198. In some aspects, 916 may include 917, 918, or 919.

In one aspect, the indication of the FD capability of the UE may be associated with a set of RACH resources used for the initial access procedure. At 917, the UE may transmit a RACH message in the first RO in the first set of ROs associated with the FD capability of the UE. The at least one RACH resource configuration may include the first RO as selected at 914. To transmit the indication of the FD capability of the UE, the UE may be configured to transmit a RACH message in the first RO selected at 914 associated with the FD capability of the UE. For example, at 816, the UE 802 may transmit an indication of FD capability of the UE during initial access procedure by transmitting a RACH message in the first RO in the first set of ROs associated with the FD capability of the UE. Furthermore, 917 may be performed by the early FD capacity indicating component 198.

At 918, the UE may transmit a RACH message including the first RACH preamble as selected at 914 to the network node. The at least one RACH resource configuration may include a preamble partitioning. To transmit the indication of the FD capability of the UE, the UE may transmit the RACH message including the first RACH preamble selected at 914 to the network node. Based on the preamble transmitted to the network node, the network node may identify the FD capability of the UE based on the preamble received in the Msg3 or the MsgA. For example, at 816, the UE 802 may transmit a RACH message in the first RO in the first set of ROs associated with the FD capability of the UE. Furthermore, 918 may be performed by the early FD capacity indicating component 198.

At 919, the UE may transmit the indication of the FD capability of the UE in at least one of an RRC message or a MAC-CE. In another aspect, the indication of the FD capability of the UE may be transmitted in one of the Msg3 or the MsgA. Here, the indication of the FD capability of the UE may be transmitted in a MAC-CE or an RRC message. For example, at 816, the UE 802 may transmit the indication of the FD capability of the UE in at least one of an RRC message or a MAC-CE. Furthermore, 919 may be performed by the early FD capacity indicating component 198.

In one example, the MAC-CE may include the FD capability of the UE. For example, the MAC-CE may be one-byte MAC-CE to indicate the FD capability of the UE, and the MAC-CE may include a bitmap or the ID of the FD capability of the UE. Here, each bit field of the bitmap may indicate whether the UE supports each of the FD-aware HD UE, or FD operation in the Mode1, the Mode2, or the Mode3. The UE may use at least one of the bit fields of the MAC-CE to indicate other specifications of the FD operation, such as minimum frequency separation between the UL/DL sub-bands for SBFD, max overlapping BW between the UL/DL sub-bands, maximum transmit power, maximum timing advance, etc., to enable the FD operation of the UE. The MAC-CE may also be used to indicate other capabilities of the UE or features supported by the UE. For example, at least one of the bit fields of the MAC-CE may indicate that the UE may have a capability to support at least one of a coverage enhancement in one network slicing, working for network slicing, SDT, or that the UE may have a reduced capability or that the UE may have at least one process relaxed.

In another example, the RRC message may include the indication of the FD capability of the UE. The RRC message may include a bitmap or an FD capability ID to indicate the FD capability of the UE 802. The bitmap or the FD capability ID in the RRC message may include at least one of other specifications of the FD operation or indication other capabilities of the UE 802 or features supported by the UE.

In another example, the indication of the FD capability may be transmitted in a dedicated medium access control (MAC) subheader of a MAC PDU for a RRC message. That is, the UE may use a dedicated LCID value of a subheader of a MAC PDU transmitted in the PUSCH of the Msg1 or MsgA during the RACH procedure. For example, the UE may use the LCID value of a subheader for the CCCH message to specify that the UE is the FD-aware HD UE or the FD UE.

In another example, the indication of the FD capability may be transmitted in a reserved bit of a MAC subheader used for early indication. For example, when the subheader of the CCCH message has a R/R/LCID structure, the UE may use the first reserved bit-field to indicate whether the UE is one of the FD-aware HD UE or FD capable UE or the UE is the legacy HD UE.

In another aspect, the indication of the FD capability of the UE may be associated with a DMRS of one of a Msg3 or a MsgA. The network node may configure, at 909, a dedicated DMRS resource common for the FD-aware HD UE and the FD UE, or configure a plurality of DMRS resources, each of DMRS resource of the plurality of DMRS resources being associated with one of the FD-aware HD UE, or the FD UE supporting operation in the Mode1, the Mode2, or the Mode3. The UE may include the dedicated DMRS resource in the PUSCH transmitted in the Msg3 or MsgA based on the FD capability of the UE, and the network node may identify the FD capability of the UE based on the DMRS resource included in the PUSCH received in the Msg3 or MsgA.

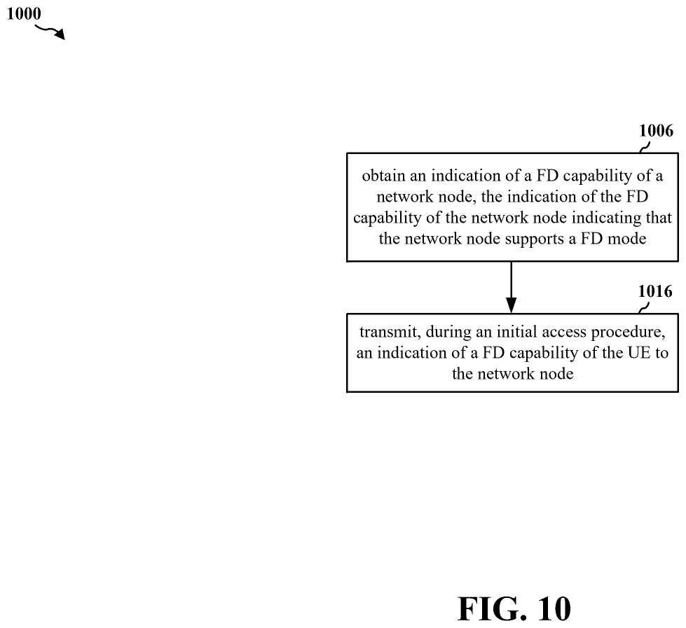

FIG. 10 is a flowchart 1000 of a method of wireless communication. The method may be performed by a UE (e.g., the UE 104/802; the apparatus 1304). The UE may transmit an early indication of the FD capability of the UE to a network node during the initial access procedure (e.g., RACH procedure), and the network node may receive the early indication of the FD capability to improve the efficiency in resource allocation based on the FD capability of the UE. The UE may obtain an indication of an FD capability of a network node, the indication of the FD capability of the network node indicating that the network node supports an FD mode, and transmit, during an initial access procedure, an indication of an FD capability of the UE to the network node. The network node may receive the indication of the FD capability of the UE, and configure one or more resources for the UE based on the received FD capability of the UE.

The UE may have at least one of the following FD capabilities: (i) the UE being in a half-duplex (HD) mode and having awareness of the FD mode (e.g., FD-aware HD UE), (ii) the UE being in the FD mode configured with non-overlapping UL/DL sub-bands (e.g., FD UE operating in Mode1), (iii) the UE being in the FD mode configured with partially overlapping UL/DL sub-bands (e.g., FD UE operating in Mode2), or (iv) the UE being in the FD mode configured with fully overlapping UL/DL sub-bands (e.g., FD UE operating in Mode3).

At 1006, the UE may obtain an indication of an FD capability of a network node, the indication of the FD capability of the network node indicating that the network node supports an FD mode. For example, at 806, the UE 802 may obtain an indication of an FD capability of a network node 804, the indication of the FD capability of the network node 804 indicating that the network node 804 supports an FD mode. Furthermore, 1006 may be performed by an early FD capacity indicating component 198.

In one aspect, the indication of the FD capability of the UE may be associated with a set of RACH resources used for the initial access procedure. That is, the indication of the UE's FD capability may be indicated in an implicit manner, and the UE may be configured to indicate the UE's FD capability based on one or more characteristics of the RACH message transmitted during the initial access procedure to the network node. The network may obtain the indication of the UE's FD capability based on the one or more characteristics of the RACH message received from the UE during the initial access procedure.

In another aspect, the network node may configure multiple (or separate) RACH resource configurations for different UEs with based on their FD capabilities. That is, the UE may be configured to select the SSB or CSI-RS and the associated RO based on its FD capability. Here, the indication of the FD capability of the UE may indicate one of the following capability of the UE: (i) the UE is in an HD mode and has awareness of the FD mode (e.g., the FD-aware HD UE), (ii) the UE is in the FD mode configured with non-overlapping UL/DL sub-bands (e.g., the FD UE in the Mode1), (iii) the UE is in the FD mode configured with partially overlapping UL/DL sub-bands (e.g., the FD UE in the Mode2), or (iv) the UE is in the FD mode configured with fully overlapping UL/DL sub-bands (e.g., the FD UE in the Mode3).

The network node may configure separate RACH resource configurations (e.g., different RACH preambles or RACH occasions (ROs)) for UEs with different FD capabilities, and the network may configure separate RACH resource or separate ROs, and each UE may transmit the RACH message (e.g., Msg1, Msg3, or MsgA) to the network node using the RO associated with the FD capability of the UE.

At 1016, the UE may transmit, during an initial access procedure, an indication of an FD capability of the UE to the network node. Here, the indication of the FD capability of the UE may indicate one of: (i) the UE being in an HD mode and having awareness of the FD mode, (ii) the UE being in the FD mode configured with non-overlapping UL/DL sub-bands, (iii) the UE being in the FD mode configured with partially overlapping UL/DL sub-bands, or (iv) the UE being in the FD mode configured with fully overlapping UL/DL sub-bands. For example, at 816, the UE 802 may transmit, during an initial access procedure, an indication of an FD capability of the UE 802 to the network node 804. Furthermore, 1016 may be performed by the early FD capacity indicating component 198.

In one aspect, the indication of the FD capability of the UE may be associated with a set of RACH resources used for the initial access procedure. In one example, the UE may transmit a RACH message in the first RO in the first set of ROs associated with the FD capability of the UE. The at least one RACH resource configuration may include the first RO. To transmit the indication of the FD capability of the UE, the UE may be configured to transmit a RACH message in the first RO associated with the FD capability of the UE.

In another example, the UE may transmit a RACH message including the first RACH preamble to the network node. The at least one RACH resource configuration may include a preamble partitioning. To transmit the indication of the FD capability of the UE, the UE may transmit the RACH message including the first RACH preamble to the network node. Based on the preamble transmitted to the network node, and the network node may identify the FD capability of the UE based on the preamble received in the Msg3 or the MsgA.

In another aspect, the UE may transmit the indication of the FD capability of the UE in at least one of an RRC message or a MAC-CE. The indication of the FD capability of the UE may be transmitted in one of the Msg3 or the MsgA. Here, the indication of the FD capability of the UE may be transmitted in a MAC-CE or an RRC message.

In one example, the MAC-CE may include the FD capability of the UE. For example, the MAC-CE may be one-byte MAC-CE to indicate the FD capability of the UE, and the MAC-CE may include a bitmap or the ID of the FD capability of the UE. Here, each bit field of the bitmap may indicate whether the UE supports each of the FD-aware HD UE, or FD operation in the Mode1, the Mode2, or the Mode3. The UE may use at least one of the bit fields of the MAC-CE to indicate other specifications of the FD operation, such as minimum frequency separation between the UL/DL sub-bands for SBFD, max overlapping BW between the UL/DL sub-bands, maximum transmit power, maximum timing advance, etc., to enable the FD operation of the UE. The MAC-CE may also be used to indicate other capabilities of the UE or features supported by the UE. For example, at least one of the bit fields of the MAC-CE may indicate that the UE may have a capability to support at least one of a coverage enhancement in one network slicing, working for network slicing, SDT, or that the UE may have a reduced capability or that the UE may have at least one process relaxed.

In another example, the RRC message may include the indication of the FD capability of the UE. The RRC message may include a bitmap or an FD capability ID to indicate the FD capability of the UE 802. The bitmap or the FD capability ID in the RRC message may include at least one of other specifications of the FD operation or indication other capabilities of the UE 802 or features supported by the UE.

In another example, the indication of the FD capability may be transmitted in a dedicated medium access control (MAC) subheader of a MAC PDU for a RRC message. That is, the UE may use a dedicated LCID value of a subheader of a MAC PDU transmitted in the PUSCH of the Msg1 or MsgA during the RACH procedure. For example, the UE may use the LCID value of a subheader for the CCCH message to specify that the UE is the FD-aware HD UE or the FD UE.

In another example, the indication of the FD capability may be transmitted in a reserved bit of a MAC subheader used for early indication. For example, when the subheader of the CCCH message has a R/R/LCID structure, the UE may use the first reserved bit-field to indicate whether the UE is one of the FD-aware HD UE or FD capable UE or the UE is the legacy HD UE.

In another aspect, the indication of the FD capability of the UE may be associated with a DMRS of one of a Msg3 or a MsgA. The network node may configure a dedicated DMRS resource common for the FD-aware HD UE and the FD UE, or configure a plurality of DMRS resources, each of DMRS resource of the plurality of DMRS resources being associated with one of the FD-aware HD UE, or the FD UE supporting operation in the Mode1, the Mode2, or the Mode3. The UE may include the dedicated DMRS resource in the PUSCH transmitted in the Msg3 or MsgA based on the FD capability of the UE, and the network node may identify the FD capability of the UE based on the DMRS resource included in the PUSCH received in the Msg3 or MsgA.

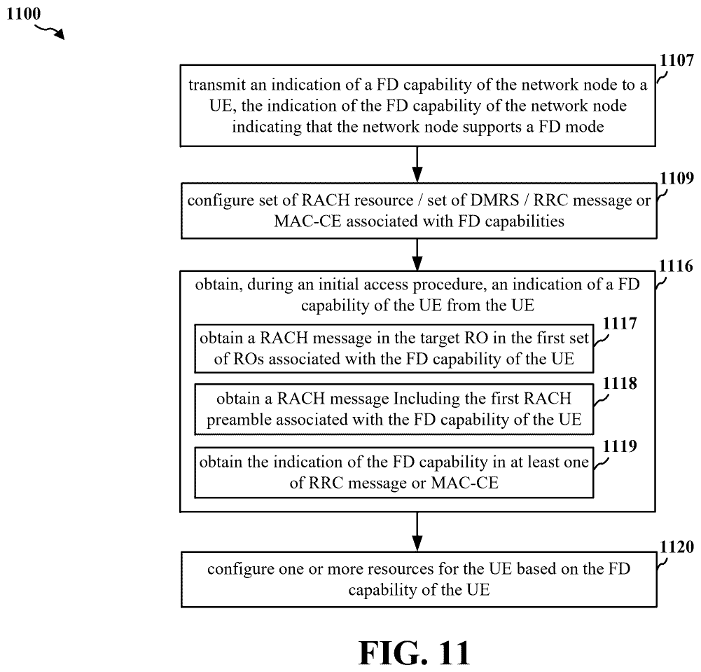

FIG. 11 is a flowchart 1100 of a method of wireless communication. The method may be performed by a network node (e.g., the base station 102; the network node 804; the network entity 1402/1560). A UE may transmit an early indication of the FD capability of the UE to the network node during the initial access procedure (e.g., RACH procedure), and the network node may receive the early indication of the FD capability to improve the efficiency in resource allocation based on the FD capability of the UE. The network node may receive an early indication of the FD capability of the UE during an initial access procedure, and configure one or more resources for the UE based on the FD capability of the UE.

At 1107, the base station may transmit an indication of an FD capability of the network node to the UE, and the indication of the FD capability of the network node may indicate that the network node may support an FD mode. For example, at 807, the network node 804 may transmit an indication of an FD capability of the network node 804 to the UE 802, and the indication of the FD capability of the network node 804 may indicate that the network node 804 may support an FD mode. Furthermore, 1107 may be performed by an early FD capacity identifying component 199.

AT 1109, the network node may configure a set of RACH resource, a set of DMRS, or an RRC message/MAC-CE associated with FD capabilities. In one example, the set of RACH resources may include a plurality of RACH preambles associated with FD capabilities of the UE. In another example, the set of RACH resources may include a plurality of sets of ROs associated with FD capabilities of the UE. In another example, the set of DMRS transmitted in the PUSCH of the MsgA or the Msg3 may be configured to indicate the FD capabilities of the UE. In another aspect, the dedicated RRC message or the dedicated MAC-CE may be configured to transmit the FD capabilities of the UE.

At 1116, the base station may obtain, during an initial access procedure, an indication of an FD capability of the UE. Here, the indication of the FD capability of the UE may indicate one of the following capability of the UE: (i) the UE is in an HD mode and has awareness of the FD mode (e.g., the FD-aware HD UE), (ii) the UE is in the FD mode configured with non-overlapping UL/DL sub-bands (e.g., the FD UE in the Mode1), (iii) the UE is in the FD mode configured with partially overlapping UL/DL sub-bands (e.g., the FD UE in the Mode2), or (iv) the UE is in the FD mode configured with fully overlapping UL/DL sub-bands (e.g., the FD UE in the Mode3). For example, at 816, the network node 804 may receive, during an initial access procedure, an indication of an FD capability of the UE 802. Furthermore, 1116 may be performed by the early FD capacity identifying component 199. In some aspects, 1116 may include 1117, 1118, or 1119.

In one aspect, the indication of the FD capability of the UE may be associated with a set of RACH resources used for the initial access procedure. At 1117, the base station may receive a RACH message in the first RO in the first set of ROs associated with the FD capability of the UE. To obtain the indication of the FD capability of the UE, the network node may be configured to obtain a RACH message in the first RO associated with the FD capability of the UE. For example, at 816, the network node 804 may obtain an indication of FD capability of the UE during initial access procedure by obtaining a RACH message in the first RO in the first set of ROs associated with the FD capability of the UE. Furthermore, 1117 may be performed by the early FD capacity identifying component 199.

At 1118, the network node may obtain a RACH message including a first RACH preamble associated with the FD capability of the UE. The at least one RACH resource configuration may include a preamble partitioning. The network node may identify the FD capability of the UE based on the preamble obtained in the Msg3 or the MsgA. For example, at 816, the network node 804 may obtain an indication of FD capability of the UE during initial access procedure by a RACH message including a first RACH preamble associated with the FD capability of the UE. Furthermore, 1118 may be performed by the early FD capacity identifying component 199.

At 1119, the network node may obtain the indication of the FD capability of the UE in at least one of an RRC message or a MAC-CE. In another aspect, the indication of the FD capability of the UE may be transmitted in one of the Msg3 or the MsgA. Here, the indication of the FD capability of the UE may be transmitted in a MAC-CE or an RRC message. For example, at 816, the network node 804 may obtain the indication of the FD capability of the UE in at least one of an RRC message or a MAC-CE. Furthermore, 1119 may be performed by the early FD capacity indicating component 198.

In one example, the MAC-CE may include the FD capability of the UE. For example, the MAC-CE may be one-byte MAC-CE to indicate the FD capability of the UE, and the MAC-CE may include a bitmap or the ID of the FD capability of the UE. Here, each bit field of the bitmap may indicate whether the UE supports each of the FD-aware HD UE, or FD operation in the Mode1, the Mode2, or the Mode3. The UE may use at least one of the bit fields of the MAC-CE to indicate other specifications of the FD operation, such as minimum frequency separation between the UL/DL sub-bands for SBFD, max overlapping BW between the UL/DL sub-bands, maximum transmit power, maximum timing advance, etc., to enable the FD operation of the UE. The MAC-CE may also be used to indicate other capabilities of the UE or features supported by the UE. For example, at least one of the bit fields of the MAC-CE may indicate that the UE may have a capability to support at least one of a coverage enhancement in one network slicing, working for network slicing, SDT, or that the UE may have a reduced capability or that the UE may have at least one process relaxed.

In another example, the RRC message may include the indication of the FD capability of the UE. The RRC message may include a bitmap or an FD capability ID to indicate the FD capability of the UE 802. The bitmap or the FD capability ID in the RRC message may include at least one of other specifications of the FD operation or indication other capabilities of the UE 802 or features supported by the UE.

In another example, the indication of the FD capability may be transmitted in a dedicated medium access control (MAC) subheader of a MAC PDU for a RRC message. That is, the UE may use a dedicated LCID value of a subheader of a MAC PDU transmitted in the PUSCH of the Msg1 or MsgA during the RACH procedure. For example, the UE may use the LCID value of a subheader for the CCCH message to specify that the UE is the FD-aware HD UE or the FD UE.

In another example, the indication of the FD capability may be transmitted in a reserved bit of a MAC subheader used for early indication. For example, when the subheader of the CCCH message has a R/R/LCID structure, the UE may use the first reserved bit-field to indicate whether the UE is one of the FD-aware HD UE or FD capable UE or the UE is the legacy HD UE.

In another aspect, the indication of the FD capability of the UE may be associated with a DMRS of one of a Msg3 or a MsgA. The network node may configure a dedicated DMRS resource common for the FD-aware HD UE and the FD UE, or configure, at 1109, a plurality of DMRS resources, each of DMRS resource of the plurality of DMRS resources being associated with one of the FD-aware HD UE, or the FD UE supporting operation in the Mode1, the Mode2, or the Mode3. The UE may include the dedicated DMRS resource in the PUSCH transmitted in the Msg3 or MsgA based on the FD capability of the UE, and the network node may identify the FD capability of the UE based on the DMRS resource included in the PUSCH received in the Msg3 or MsgA.

At 1120, the base station may configure one or more resources for the UE based on the FD capability of the UE. The UE may transmit an early indication of the UE's capability during the RACH procedure, and the network node may configure one or more resources for the UE based on the received indication of the FD capability of the UE. For example, at 820, the network node 804 may configure one or more resources for the UE 802 based on the FD capability of the UE 802. Furthermore, 1120 may be performed by the early FD capacity identifying component 199.

In one example, based on the early indication of the FD capability of the UE, the network node may identify that the UE may have a capability to support at least one of a coverage enhancement in one network slicing. In another example, based on the early indication of the FD capability of the UE, the network node may identify that the UE may support the network slicing. In another example, based on the early indication of the FD capability of the UE, the network node may identify that the UE may support the SDT. In another example, based on the early indication of the FD capability of the UE, the network node may identify that the UE may have a reduced capability. In another example, based on the early indication of the FD capability of the UE, the network node may identify that that the UE may have at least one process relaxed.

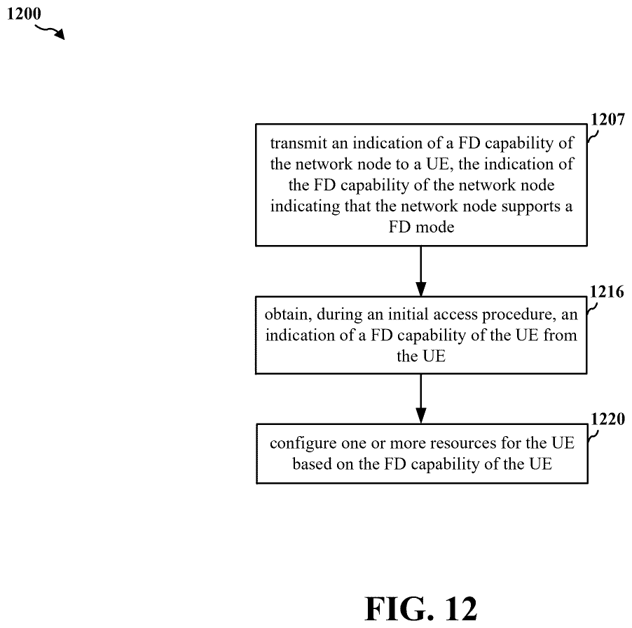

FIG. 12 is a flowchart 1200 of a method of wireless communication. The method may be performed by a network node (e.g., the base station 102; the network node 804; the network entity 1402/1560). A UE may transmit an early indication of the FD capability of the UE to the network node during the initial access procedure (e.g., RACH procedure), and the network node may receive the early indication of the FD capability to improve the efficiency in resource allocation based on the FD capability of the UE. The network node may receive an early indication of the FD capability of the UE during an initial access procedure, and configure one or more resources for the UE based on the FD capability of the UE.

At 1207, the base station may transmit an indication of an FD capability of the network node to the UE, and the indication of the FD capability of the network node may indicate that the network node may support an FD mode. For example, at 807, the network node 804 may transmit an indication of an FD capability of the network node 804 to the UE 802, and the indication of the FD capability of the network node 804 may indicate that the network node 804 may support an FD mode. Furthermore, 1207 may be performed by an early FD capacity identifying component 199.

AT 1109, the network node may configure a set of RACH resource, a set of DMRS, or an RRC message/MAC-CE associated with FD capabilities. In one example, the set of RACH resources may include a plurality of RACH preambles associated with FD capabilities of the UE. In another example, the set of RACH resources may include a plurality of sets of ROs associated with FD capabilities of the UE. In another example, the set of DMRS transmitted in the PUSCH of the MsgA or the Msg3 may be configured to indicate the FD capabilities of the UE. In another aspect, the dedicated RRC message or the dedicated MAC-CE may be configured to transmit the FD capabilities of the UE.

At 1216, the base station may obtain, during an initial access procedure, an indication of an FD capability of the UE. Here, the indication of the FD capability of the UE may indicate one of the following capability of the UE: (i) the UE is in an HD mode and has awareness of the FD mode (e.g., the FD-aware HD UE), (ii) the UE is in the FD mode configured with non-overlapping UL/DL sub-bands (e.g., the FD UE in the Mode1), (iii) the UE is in the FD mode configured with partially overlapping UL/DL sub-bands (e.g., the FD UE in the Mode2), or (iv) the UE is in the FD mode configured with fully overlapping UL/DL sub-bands (e.g., the FD UE in the Mode3). For example, at 816, the network node 804 may receive, during an initial access procedure, an indication of an FD capability of the UE 802. Furthermore, 1216 may be performed by the early FD capacity identifying component 199. In some aspects, 1216 may include 1217.

In one aspect, the indication of the FD capability of the UE may be associated with a set of RACH resources used for the initial access procedure. In one example, the network node may obtain a RACH message in the first RO in the first set of ROs associated with the FD capability of the UE. The at least one RACH resource configuration may include the first RO. To transmit the indication of the FD capability of the UE, the UE may be configured to transmit a RACH message in the first RO selected at 914 associated with the FD capability of the UE.

In another example, the network node may obtain a RACH message including the first RACH preamble from the UE. The at least one RACH resource configuration may include a preamble partitioning. To obtain the indication of the FD capability of the UE, the network node may obtain the RACH message including the first RACH preamble from the UE. Based on the preamble transmitted to the network node, and the network node may identify the FD capability of the UE based on the preamble received in the Msg3 or the MsgA.

In another aspect, the network node may obtain the indication of the FD capability of the UE in at least one of an RRC message or a MAC-CE. The indication of the FD capability of the UE may be transmitted in one of the Msg3 or the MsgA. Here, the indication of the FD capability of the UE may be transmitted in a MAC-CE or an RRC message.

In one example, the MAC-CE may include at least one configuration associated with the FD capability of the UE. For example, the MAC-CE may be one-byte MAC-CE to indicate the FD capability of the UE, and the MAC-CE may include a bitmap or the ID of the FD capability of the UE. Here, each bit field of the bitmap may indicate whether the UE supports each of the FD-aware HD UE, or FD operation in the Mode1, the Mode2, or the Mode3. The UE may use at least one of the bit fields of the MAC-CE to indicate other specifications of the FD operation, such as minimum frequency separation between the UL/DL sub-bands for SBFD, max overlapping BW between the UL/DL sub-bands, maximum transmit power, maximum timing advance, etc., to enable the FD operation of the UE. The MAC-CE may also be used to indicate other capabilities of the UE or features supported by the UE. For example, at least one of the bit fields of the MAC-CE may indicate that the UE may have a capability to support at least one of a coverage enhancement in one network slicing, working for network slicing, SDT, or that the UE may have a reduced capability or that the UE may have at least one process relaxed.

In another example, the RRC message may include the indication of the FD capability of the UE. The RRC message may include a bitmap or an FD capability ID to indicate the FD capability of the UE 802. The bitmap or the FD capability ID in the RRC message may include at least one of other specifications of the FD operation or indication other capabilities of the UE 802 or features supported by the UE.

In another example, the indication of the FD capability may be transmitted in a dedicated medium access control (MAC) subheader of a MAC PDU for a radio resource control (RRC) message. That is, the UE may use a dedicated LCID value of a subheader of a MAC PDU in the PUSCH of the Msg1 or MsgA during the RACH procedure. For example, the UE may use the LCID value of a subheader for the CCCH message to specify that the UE is the FD-aware HD UE or the FD UE.

In another example, the indication of the FD capability may be transmitted in a reserved bit of a MAC subheader used for early indication. For example, when the subheader of the CCCH message has a R/R/LCID structure, the UE may use the first reserved bit-field to indicate whether the UE is one of the FD-aware HD UE or FD capable UE or the UE is the legacy HD UE.

In another aspect, the indication of the FD capability of the UE may be associated with a DMRS of one of a Msg3 or a MsgA. The network node may configure a dedicated DMRS resource common for the FD-aware HD UE and the FD UE, or configure a plurality of DMRS resources, each of DMRS resource of the plurality of DMRS resources being associated with one of the FD-aware HD UE, or the FD UE supporting operation in the Mode1, the Mode2, or the Mode3. The UE may include the dedicated DMRS resource in the PUSCH transmitted in the Msg3 or MsgA based on the FD capability of the UE, and the network node may identify the FD capability of the UE based on the DMRS resource included in the PUSCH received in the Msg3 or MsgA.

At 1220, the base station may configure one or more resources for the UE based on the FD capability of the UE. The UE may transmit an early indication of the UE's capability during the RACH procedure, and the network node may configure one or more resources for the UE based on the received indication of the FD capability of the UE. For example, at 820, the network node 804 may configure one or more resources for the UE 802 based on the FD capability of the UE 802. Furthermore, 1220 may be performed by the early FD capacity identifying component 199.

In one example, based on the early indication of the FD capability of the UE, the network node may identify that the UE may have a capability to support at least one of a coverage enhancement in one network slicing. In another example, based on the early indication of the FD capability of the UE, the network node may identify that the UE may support the network slicing. In another example, based on the early indication of the FD capability of the UE, the network node may identify that the UE may support the SDT. In another example, based on the early indication of the FD capability of the UE, the network node may identify that the UE may have a reduced capability. In another example, based on the early indication of the FD capability of the UE, the network node may identify that that the UE may have at least one process relaxed.

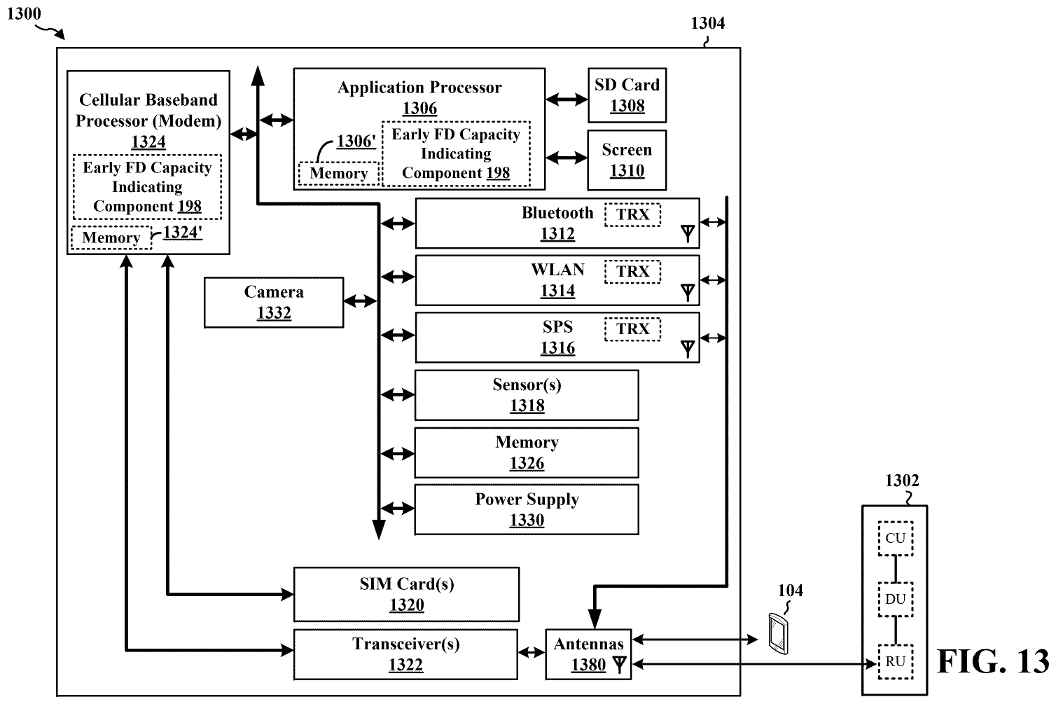

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the early FD capacity indicating component 198 may be configured to obtain an indication of an FD capability of a network node, the indication of the FD capability of the network node indicating that the network node supports an FD mode. The early FD capacity indicating component 198 may also be configured to transmit, during an initial access procedure, an indication of an FD capability of the UE to the network node. The early FD capacity indicating component 198 may be within the cellular baseband processor 1324, the application processor 1306, or both the cellular baseband processor 1324 and the application processor 1306. The early FD capacity indicating component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, may include means for obtaining an indication of a FD capability of a network node, the indication of the FD capability of the network node indicating that the network node supports an FD mode, and means for transmitting, during an initial access procedure, an indication of an FD capability of the UE to the network node. In one configuration, the indication of the FD capability of the UE indicates one of (i) the UE is in a HD mode and has awareness of the FD mode, (ii) the UE is in the FD mode configured with non-overlapping UL/DL sub-bands, (iii) the UE is in the FD mode configured with partially overlapping UL/DL sub-bands, or (iv) the UE is in the FD mode configured with fully overlapping UL/DL sub-bands. In one configuration, the indication of the FD capability of the UE is associated with a set of RACH resources used for the initial access procedure. In one configuration, the set of RACH resources includes a plurality of RACH preambles including a first RACH preamble associated with the FD capability of the UE, and the means for transmitting the indication of the FD capability of the UE is further configured to transmit a RACH message including the first RACH preamble to the network node. In one configuration, the set of RACH resources includes a plurality of sets of ROs, where a first set of ROs of the plurality of sets of ROs is associated with the FD capability of the UE, and the apparatus 1304, and in particular the cellular baseband processor 1324 and/or the application processor 1306, further includes means for selecting a first RO in the first set of ROs associated with the FD capability of the UE, where, the means for transmitting the indication of the FD capability of the UE is further configured to transmit a RACH message in the first RO in the first set of ROs associated with the FD capability of the UE. In one configuration, the set of RACH resources includes a plurality of sets of ROs including a first set of ROs, each RO of the first set of ROs overlapping at least in part with a downlink reference signal of the set of downlink reference signal in a time domain. In one configuration, the first set of ROs includes at least one of a first subset of ROs associated with a first UE capability of being in a HD mode and having awareness of the FD mode, a second subset of ROs associated with a second UE capability of being in the FD mode configured with non-overlapping UL/DL sub-bands, a third subset of ROs associated with a third UE capability of being in the FD mode configured with partially overlapping UL/DL sub-bands, or a fourth subset of ROs associated with a fourth UE capability of being in the FD mode configured with fully overlapping UL/DL sub-bands. In one configuration, the indication of the FD capability of the UE is transmitted in one of a Msg3 or a MsgA. In one configuration, the indication of the FD capability of the UE is transmitted in at least one of a RRC message or a MAC-CE. In one configuration, the indication of the FD capability is transmitted in a dedicated MAC subheader of a RRC message. In one configuration, the indication of the FD capability is transmitted in a reserved bit of a MAC subheader used for early indication. In one configuration, the indication of the FD capability of the UE is associated with a DMRS of one of a Msg3 or a MsgA. In one configuration, the means for obtaining the indication of the FD capability of the network node is configured to receive the indication of the FD capability of the network node from the network node or identify the FD capability of the network node. In one configuration, the indication of the FD capability of the UE is transmitted with at least one indication of a configuration associated with the FD capability of the UE or UE capability unrelated to FD operation. The means may be the early FD capacity indicating component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

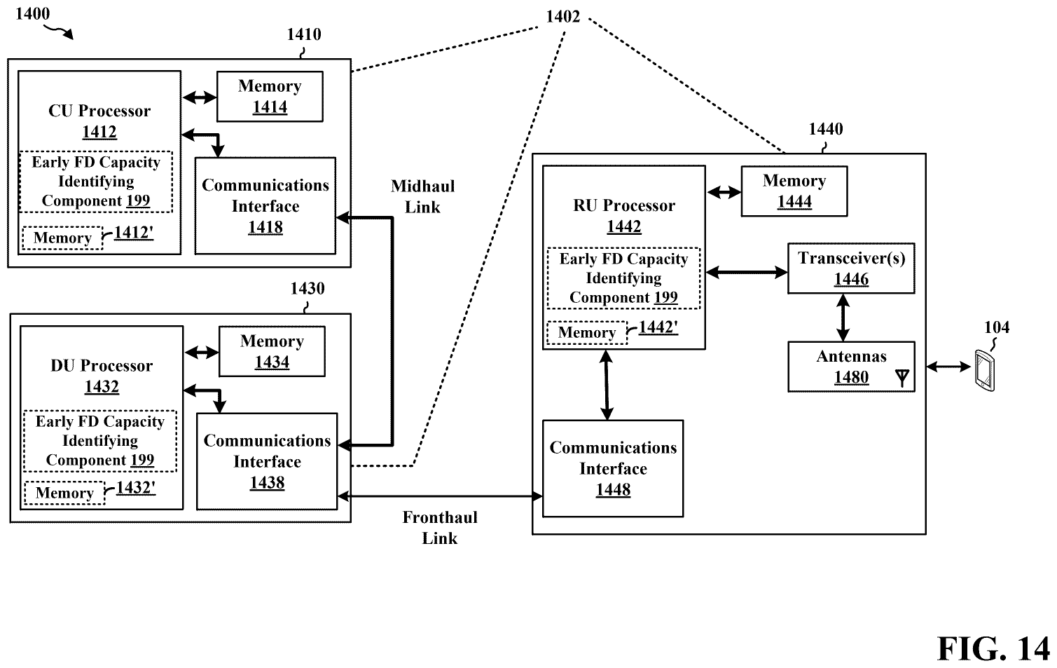

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the early FD capacity identifying component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the early FD capacity identifying component 199 may be configured to transmit an indication of an FD capability of the network node to a UE, the indication of the FD capability of the network node indicating that the network node supports an FD mode. The early FD capacity identifying component 199 may also be configured to obtain an indication of an FD capability of the UE during an initial access procedure. The early FD capacity identifying component 199 may also be configured to configure one or more resources for the UE based on the FD capability of the UE. The early FD capacity identifying component 199 may be within one or more processors of one or more of the CU 1410, DU 1430, and the RU 1440. The early FD capacity identifying component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for transmitting an indication of a FD capability of the network node for a UE, the indication of the FD capability of the network node indicating that the network node supports an FD mode, means for obtaining an indication of an FD capability of the UE during an initial access procedure, and means for configuring one or more resources for the UE based on the FD capability of the UE. In one configuration, the indication of the FD capability of the UE indicates one of (i) the UE is in a HD mode and has awareness of the FD mode, (ii) the UE is in the FD mode configured with non-overlapping UL/DL sub-bands, (iii) the UE is in the FD mode configured with partially overlapping UL/DL sub-bands, or (iv) the UE is in the FD mode configured with fully overlapping UL/DL sub-bands. In one configuration, the indication of the FD capability of the UE is associated with a set of RACH resources used for the initial access procedure. In one configuration, the network entity 1402 further includes means for configuring a set of RACH resources including a plurality of RACH preambles including a first RACH preamble associated with the FD capability of the UE, and where the means for obtaining the indication of the FD capability of the UE is further configured to receive a RACH message including the first RACH preamble. In one configuration, the network entity 1402 further includes means for configuring the set of RACH resources including a plurality of sets of ROs, where a first set of ROs of the plurality of sets of ROs is associated with the FD capability of the UE, where the means for obtaining the indication of the FD capability of the UE is further configured to receive a RACH message in a first RO in the first set of ROs associated with the FD capability of the UE. In one configuration, the network entity 1402 further includes means for configuring the set of RACH resources including a plurality of sets of ROs including a first set of ROs, each RO of the first set of ROs overlapping at least in part with a downlink reference signal of the set of downlink reference signal in a time domain. In one configuration, the first set of ROs includes at least one of a first subset of ROs associated with a first UE capability of being in a HD mode and having awareness of the FD mode, a second subset of ROs associated with a second UE capability of being in the FD mode configured with non-overlapping UL/DL sub-bands, a third subset of ROs associated with a third UE capability of being in the FD mode configured with partially overlapping UL/DL sub-bands, or a fourth subset of ROs associated with a fourth UE capability of being in the FD mode configured with fully overlapping UL/DL sub-bands. In one configuration, the indication of the FD capability of the UE is obtained in one of a Msg3 or a MsgA. In one configuration, the indication of the FD capability of the UE is obtained in at least one of a RRC message or a MAC-CE. In one configuration, the indication of the FD capability is obtained in a dedicated MAC subheader of a RRC message. In one configuration, the indication of the FD capability is obtained in a reserved bit of a MAC subheader used for early indication.

In one configuration, the indication of the FD capability of the UE is associated with a DMRS of one of a Msg3 or a MsgA. In one configuration, a message including the indication of the FD capability of the UE further includes at least one indication of a configuration associated with the FD capability of the UE or UE capability unrelated to FD operation. The means may be the early FD capacity identifying component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

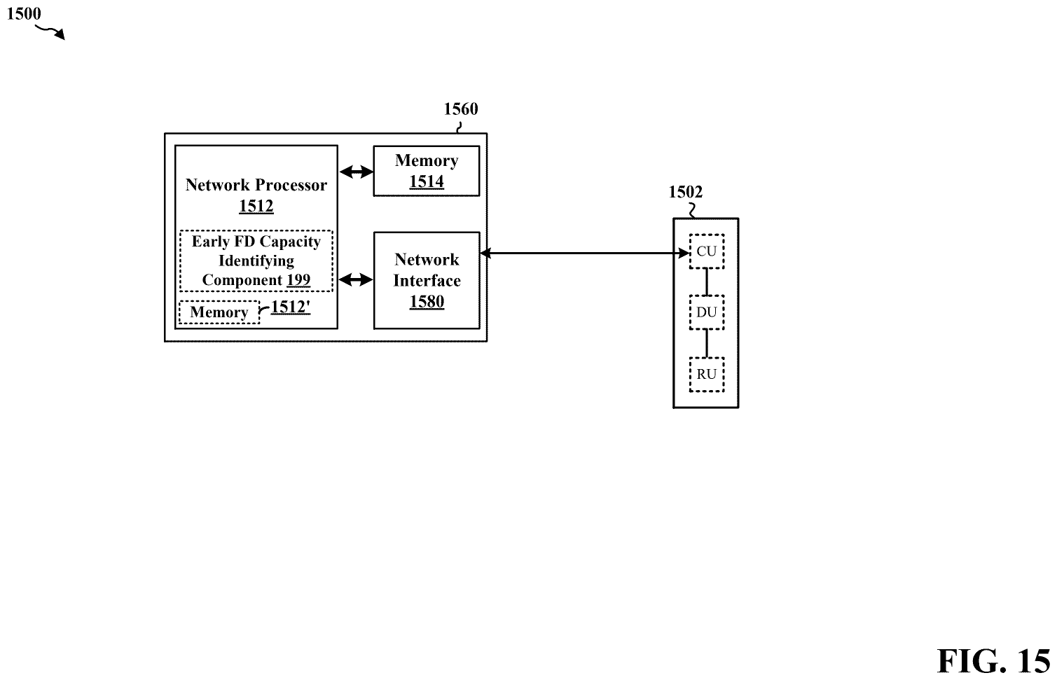

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the early FD capacity identifying component 199 is configured to transmit an indication of an FD capability of the network node to a UE, the indication of the FD capability of the network node indicating that the network node supports an FD mode. The early FD capacity identifying component 199 may also be configured to obtain an indication of an FD capability of the UE during an initial access procedure. The early FD capacity identifying component 199 may also be configured to configure one or more resources for the UE based on the FD capability of the UE. The early FD capacity identifying component 199 may be within the processor 1512. The early FD capacity identifying component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. In one configuration, the network entity 1560 includes means for transmitting an indication of a FD capability of the network node for a UE, the indication of the FD capability of the network node indicating that the network node supports an FD mode, means for obtaining an indication of an FD capability of the UE during an initial access procedure, and means for configuring one or more resources for the UE based on the FD capability of the UE. In one configuration, the indication of the FD capability of the UE indicates one of (i) the UE is in a HD mode and has awareness of the FD mode, (ii) the UE is in the FD mode configured with non-overlapping UL/DL sub-bands, (iii) the UE is in the FD mode configured with partially overlapping UL/DL sub-bands, or (iv) the UE is in the FD mode configured with fully overlapping UL/DL sub-bands. In one configuration, the indication of the FD capability of the UE is associated with a set of RACH resources used for the initial access procedure. In one configuration, the network entity 1560 further includes means for configuring a set of RACH resources including a plurality of RACH preambles including a first RACH preamble associated with the FD capability of the UE, and where the means for obtaining the indication of the FD capability of the UE is further configured to receive a RACH message including the first RACH preamble. In one configuration, the network entity 1560 further includes means for configuring the set of RACH resources including a plurality of sets of ROs, where a first set of ROs of the plurality of sets of ROs is associated with the FD capability of the UE, where the means for obtaining the indication of the FD capability of the UE is further configured to receive a RACH message in a first RO in the first set of ROs associated with the FD capability of the UE. In one configuration, the network entity 1560 further includes means for configuring the set of RACH resources including a plurality of sets of ROs including a first set of ROs, each RO of the first set of ROs overlapping at least in part with a downlink reference signal of the set of downlink reference signal in a time domain. In one configuration, the first set of ROs includes at least one of a first subset of ROs associated with a first UE capability of being in a HD mode and having awareness of the FD mode, a second subset of ROs associated with a second UE capability of being in the FD mode configured with non-overlapping UL/DL sub-bands, a third subset of ROs associated with a third UE capability of being in the FD mode configured with partially overlapping UL/DL sub-bands, or a fourth subset of ROs associated with a fourth UE capability of being in the FD mode configured with fully overlapping UL/DL sub-bands. In one configuration, the indication of the FD capability of the UE is obtained in one of a Msg3 or a MsgA. In one configuration, the indication of the FD capability of the UE is obtained in at least one of a RRC message or a MAC-CE. In one configuration, the indication of the FD capability is obtained in a dedicated MAC subheader of a RRC message. In one configuration, the indication of the FD capability is obtained in a reserved bit of a MAC subheader used for early indication. In one configuration, the indication of the FD capability of the UE is associated with a DMRS of one of a Msg3 or a MsgA. In one configuration, a message including the indication of the FD capability of the UE further includes at least one indication of a configuration associated with the FD capability of the UE or UE capability unrelated to FD operation. The means may be the early FD capacity identifying component 199 of the network entity 1560 configured to perform the functions recited by the means.

According to some embodiments of the current disclosure, a UE may obtain an indication of an FD capability of a network node, the indication of the FD capability of the network node indicating that the network node supports an FD mode, and transmit, during an initial access procedure, an indication of an FD capability of the UE to the network node. The network node may transmit an indication of an FD capability of the network node to a UE, the indication of the FD capability of the network node indicating that the network node supports an FD mode, obtain an indication of an FD capability of the UE during an initial access procedure, and configure one or more resources for the UE based on the FD capability of the UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including obtaining an indication of a FD capability of a network node, the indication of the FD capability of the network node indicating that the network node supports an FD mode, and transmitting, during an initial access procedure, an indication of an FD capability of the UE to the network node.

Aspect 2 is the method of aspect 1, where the indication of the FD capability of the UE indicates one of (i) the UE is in a HD mode and has awareness of the FD mode, (ii) the UE is in the FD mode configured with non-overlapping UL/DL sub-bands, (iii) the UE is in the FD mode configured with partially overlapping UL/DL sub-bands, or (iv) the UE is in the FD mode configured with fully overlapping UL/DL sub-bands.

Aspect 3 is the method of any of aspects 1 and 2, where the indication of the FD capability of the UE is associated with a set of RACH resources used for the initial access procedure.

Aspect 4 is the method of aspect 3, where the set of RACH resources includes a plurality of RACH preambles including a first RACH preamble associated with the FD capability of the UE, and the transmitting the indication of the FD capability of the UE further includes transmitting a RACH message including the first RACH preamble to the network node.

Aspect 5 is the method of any of aspects 3 and 4, where the set of RACH resources includes a plurality of sets of ROs, where a first set of ROs of the plurality of sets of ROs is associated with the FD capability of the UE, and the method further including selecting a first RO in the first set of ROs associated with the FD capability of the UE, the transmitting the indication of the FD capability of the UE further including transmitting a RACH message in the first RO in the first set of ROs associated with the FD capability of the UE.

Aspect 6 is the method of any of aspects 3 to 5, where the set of RACH resources includes a plurality of sets of ROs including a first set of ROs, each RO of the first set of ROs overlapping at least in part with a downlink reference signal of the set of downlink reference signal in a time domain.

Aspect 7 is the method of aspect 6, where the first set of ROs includes at least one of a first subset of ROs associated with a first UE capability of being in a HD mode and having awareness of the FD mode, a second subset of ROs associated with a second UE capability of being in the FD mode configured with non-overlapping UL/DL sub-bands, a third subset of ROs associated with a third UE capability of being in the FD mode configured with partially overlapping UL/DL sub-bands, or a fourth subset of ROs associated with a fourth UE capability of being in the FD mode configured with fully overlapping UL/DL sub-bands.

Aspect 8 is the method of any of aspects 1 to 7, where the indication of the FD capability of the UE is transmitted in one of a Msg3 or a MsgA.

Aspect 9 is the method of aspect 8, where the indication of the FD capability of the UE is transmitted in at least one of a RRC message or a MAC-CE.

Aspect 10 is the method of any of aspects 8 and 9, where the indication of the FD capability is transmitted in a dedicated MAC subheader of a RRC message.

Aspect 11 is the method of any of aspects 8 to 10, where the indication of the FD capability is transmitted in a reserved bit of a MAC subheader used for early indication.

Aspect 12 is the method of any of aspects 8 to 11, where the indication of the FD capability of the UE is associated with a DMRS of one of a Msg3 or a MsgA.

Aspect 13 is the method of any of aspects 1 to 12, where the obtaining the indication of the FD capability of the network node further includes receiving the indication of the FD capability of the network node from the network node, or identifying the FD capability of the network node.

Aspect 14 is the method of any of aspects 1 to 13, where the indication of the FD capability of the UE is transmitted with at least one indication of a configuration associated with the FD capability of the UE or UE capability unrelated to FD operation.

Aspect 15 is an apparatus for wireless communication including at least one processor coupled to a memory and configured to implement any of aspects 1 to 14, further including a transceiver coupled to the at least one processor.

Aspect 16 is an apparatus for wireless communication including means for implementing any of aspects 1 to 14.

Aspect 17 is a non-transitory computer-readable medium storing computer executable code, where the code when executed by a processor causes the processor to implement any of aspects 1 to 14.

Aspect 18 is a method of wireless communication at a network node, including transmitting an indication of a FD capability of the network node for a UE, the indication of the FD capability of the network node indicating that the network node supports an FD mode, obtaining an indication of an FD capability of the UE during an initial access procedure, and configuring one or more resources for the UE based on the FD capability of the UE.

Aspect 19 is the method of aspect 18, where the indication of the FD capability of the UE indicates one of (i) the UE is in a HD mode and has awareness of the FD mode, (ii) the UE is in the FD mode configured with non-overlapping UL/DL sub-bands, (iii) the UE is in the FD mode configured with partially overlapping UL/DL sub-bands, or (iv) the UE is in the FD mode configured with fully overlapping UL/DL sub-bands.

Aspect 20 is the method of any of aspects 18 and 19, where the indication of the FD capability of the UE is associated with a set of RACH resources used for the initial access procedure.

Aspect 21 is the method of aspect 20, where method further includes configuring a set of RACH resources including a plurality of RACH preambles including a first RACH preamble associated with the FD capability of the UE, and the obtaining the indication of the FD capability of the UE further includes receiving a RACH message including the first RACH preamble.

Aspect 22 is the method of any of aspects 20 and 21, where the at least one processor is configured to configure the set of RACH resources including a plurality of sets of ROs, where a first set of ROs of the plurality of sets of ROs is associated with the FD capability of the UE, where the obtaining the indication of the FD capability of the UE further includes receiving a RACH message in a first RO in the first set of ROs associated with the FD capability of the UE.

Aspect 23 is the method of any of aspects 20 to 22, further including configuring the set of RACH resources including a plurality of sets of ROs including a first set of ROs, each RO of the first set of ROs overlapping at least in part with a downlink reference signal of the set of downlink reference signal in a time domain.

Aspect 24 is the method of aspect 23, where the first set of ROs includes at least one of a first subset of ROs associated with a first UE capability of being in a HD mode and having awareness of the FD mode, a second subset of ROs associated with a second UE capability of being in the FD mode configured with non-overlapping UL/DL sub-bands, a third subset of ROs associated with a third UE capability of being in the FD mode configured with partially overlapping UL/DL sub-bands, or a fourth subset of ROs associated with a fourth UE capability of being in the FD mode configured with fully overlapping UL/DL sub-bands.

Aspect 25 is the method of any of aspects 18 to 24, where the indication of the FD capability of the UE is obtained in one of a Msg3 or a MsgA.

Aspect 26 is the method of aspect 25, where the indication of the FD capability of the UE is obtained in at least one of a RRC message or a MAC-CE.

Aspect 27 is the method of any of aspects 24 to 26, where the indication of the FD capability is obtained in a dedicated MAC subheader of a RRC message.

Aspect 28 is the method of any of aspects 24 to 27, where the indication of the FD capability is obtained in a reserved bit of a MAC subheader used for early indication.

Aspect 29 is the method of any of aspects 18 to 28, where the indication of the FD capability of the UE is associated with a DMRS of one of a Msg3 or a MsgA.

Aspect 30 is the method of any of aspects 18 to 29, where a message including the indication of the FD capability of the UE further includes at least one indication of a configuration associated with the FD capability of the UE or UE capability unrelated to FD operation.

Aspect 31 is an apparatus for wireless communication including at least one processor coupled to a memory and configured to implement any of aspects 18 to 30, further including a transceiver coupled to the at least one processor.

Aspect 32 is an apparatus for wireless communication including means for implementing any of aspects 18 to 30.

Aspect 33 is a non-transitory computer-readable medium storing computer executable code, where the code when executed by a processor causes the processor to implement any of aspects 18 to 30.

What is claimed is:

1. An apparatus for wireless communication at a user equipment (UE), comprising:
a memory; and
at least one processor coupled to the memory and, based at least in part on information stored in the memory, the at least one processor is configured to:
obtain an indication of a full-duplex (FD) capability of a network node, the indication of the FD capability of the network node indicating that the network node supports an FD mode; and
transmit, during an initial access procedure, an indication of an FD capability of the UE to the network node.

2. The apparatus of claim 1, further comprising a transceiver coupled to the at least one processor,
wherein the indication of the FD capability of the UE indicates one of: (i) the UE is in a half-duplex (HD) mode and has awareness of the FD mode, (ii) the UE is in the FD mode configured with non-overlapping uplink (UL)/downlink (DL) sub-bands, (iii) the UE is in the FD mode configured with partially overlapping UL/DL sub-bands, or (iv) the UE is in the FD mode configured with fully overlapping UL/DL sub-bands.

3. The apparatus of claim 1, wherein the indication of the FD capability of the UE is associated with a set of random access channel (RACH) resources used for the initial access procedure.

4. The apparatus of claim 3, wherein the set of RACH resources includes a plurality of RACH preambles including a first RACH preamble associated with the FD capability of the UE,
wherein, to transmit the indication of the FD capability of the UE, the at least one processor is further configured to transmit a RACH message including the first RACH preamble to the network node.

5. The apparatus of claim 3, wherein the set of RACH resources includes a plurality of sets of RACH occasions (ROs), wherein a first set of ROs of the plurality of sets of ROs is associated with the FD capability of the UE, and
wherein the at least one processor is further configured to select a first RO in the first set of ROs associated with the FD capability of the UE,
wherein, to transmit the indication of the FD capability of the UE, the at least one processor is further configured to transmit a RACH message in the first RO in the first set of ROs associated with the FD capability of the UE.

6. The apparatus of claim 3, wherein the set of RACH resources includes a plurality of sets of RACH occasions (ROs) including a first set of ROs, each RO of the first set of ROs overlapping at least in part with a downlink reference signal of a set of downlink reference signals in a time domain.

7. The apparatus of claim 6, wherein the first set of ROs includes at least one of:
a first subset of ROs associated with a first UE capability of being in a half-duplex (HD) mode and having awareness of the FD mode;
a second subset of ROs associated with a second UE capability of being in the FD mode configured with non-overlapping uplink (UL)/downlink (DL) sub-bands;
a third subset of ROs associated with a third UE capability of being in the FD mode configured with partially overlapping UL/DL sub-bands; or
a fourth subset of ROs associated with a fourth UE capability of being in the FD mode configured with fully overlapping UL/DL sub-bands.

8. The apparatus of claim 1, wherein the indication of the FD capability of the UE is transmitted in one of a random access channel (RACH) message 3 (Msg3) or a RACH message A (MsgA).

9. The apparatus of claim 8, wherein the indication of the FD capability of the UE is transmitted in at least one of a radio resource control (RRC) message or a medium access control (MAC) control element (CE) (MAC-CE).

10. The apparatus of claim 8, wherein the indication of the FD capability is transmitted in a dedicated medium access control (MAC) subheader of a radio resource control (RRC) message.

11. The apparatus of claim 8, wherein the indication of the FD capability is transmitted in a reserved bit of a medium access control (MAC) subheader used for early indication.

12. The apparatus of claim 1, wherein the indication of the FD capability of the UE is associated with a demodulation reference signal (DMRS) of one of a random access channel (RACH) message 3 (Msg3) or a RACH message A (MsgA).

13. The apparatus of claim 1, wherein to obtain the indication of the FD capability of the network node, the at least one processor is configured to:
receive the indication of the FD capability of the network node from the network node; or
identify the FD capability of the network node.

14. The apparatus of claim 1, wherein the indication of the FD capability of the UE is transmitted with at least one indication of a configuration associated with the FD capability of the UE or a UE capability unrelated to an FD operation.

15. An apparatus for wireless communication at a network node, comprising:
a memory; and
at least one processor coupled to the memory and configured to:
transmit an indication of a full-duplex (FD) capability of the network node for a user equipment (UE), the indication of the FD capability of the network node indicating that the network node supports an FD mode;
obtain an indication of an FD capability of the UE during an initial access procedure; and
configure one or more resources for the UE based on the FD capability of the UE.

16. The apparatus of claim 15, further comprising a transceiver coupled to the at least one processor,
wherein the indication of the FD capability of the UE indicates one of: (i) the UE is in a half-duplex (HD) mode and has awareness of the FD mode, (ii) the UE is in the FD mode configured with non-overlapping uplink (UL)/downlink (DL) sub-bands, (iii) the UE is in the FD mode configured with partially overlapping UL/DL sub-bands, or (iv) the UE is in the FD mode configured with fully overlapping UL/DL sub-bands.

17. The apparatus of claim 15, wherein the indication of the FD capability of the UE is associated with a set of random access channel (RACH) resources used for the initial access procedure.

18. The apparatus of claim 17, wherein the at least one processor is configured to configure a set of RACH resources including a plurality of RACH preambles including a first RACH preamble associated with the FD capability of the UE,
wherein, to obtain the indication of the FD capability of the UE, the at least one processor is further configured to receive a RACH message including the first RACH preamble.

19. The apparatus of claim 17, wherein the at least one processor is configured to configure the set of RACH resources including a plurality of sets of RACH occasions (ROs), wherein a first set of ROs of the plurality of sets of ROs is associated with the FD capability of the UE,
wherein, to obtain the indication of the FD capability of the UE, the at least one processor is further configured to receive a RACH message in a first RO in the first set of ROs associated with the FD capability of the UE.

20. The apparatus of claim 17, wherein the at least one processor is configured to configure the set of RACH resources including a plurality of sets of RACH occasions (ROs) including a first set of ROs, each RO of the first set of ROs overlapping at least in part with a downlink reference signal of a set of downlink reference signals in a time domain.

21. The apparatus of claim 20, wherein the first set of ROs includes at least one of:
a first subset of ROs associated with a first UE capability of being in a half-duplex (HD) mode and having awareness of the FD mode;
a second subset of ROs associated with a second UE capability of being in the FD mode configured with non-overlapping uplink (UL)/downlink (DL) sub-bands;
a third subset of ROs associated with a third UE capability of being in the FD mode configured with partially overlapping UL/DL sub-bands; or
a fourth subset of ROs associated with a fourth UE capability of being in the FD mode configured with fully overlapping UL/DL sub-bands.

22. The apparatus of claim 15, wherein the indication of the FD capability of the UE is obtained in one of a random access channel (RACH) message 3 (Msg3) or a RACH message A (MsgA).

23. The apparatus of claim 22, wherein the indication of the FD capability of the UE is obtained in at least one of a radio resource control (RRC) message or a medium access control (MAC) control element (CE) (MAC-CE).

24. The apparatus of claim 21, wherein the indication of the FD capability is obtained in a dedicated medium access control (MAC) subheader of a radio resource control (RRC) message.

25. The apparatus of claim 21, wherein the indication of the FD capability is obtained in a reserved bit of a medium access control (MAC) subheader used for early indication.

26. The apparatus of claim 15, wherein the indication of the FD capability of the UE is associated with a demodulation reference signal (DMRS) of one of a random access channel (RACH) message 3 (Msg3) or a RACH message A (MsgA).

27. The apparatus of claim 15, wherein a message including the indication of the FD capability of the UE further includes at least one indication of a configuration associated with the FD capability of the UE or a UE capability unrelated to an FD operation.

28. A method for wireless communication at a user equipment (UE), comprising:
obtaining an indication of a full-duplex (FD) capability of a network node, the indication of the FD capability of the network node indicating that the network node supports an FD mode; and
transmitting, during an initial access procedure, an indication of an FD capability of the UE to the network node.

29. The method of claim 28, wherein the indication of the FD capability of the UE is associated with a set of random access channel (RACH) resources used for the initial access procedure or transmitted in one of a random access channel (RACH) message 3 (Msg3) or a RACH message A (MsgA).

30. A method for wireless communication at a network node, comprising:
transmitting an indication of a full-duplex (FD) capability of the network node for a user equipment (UE), the indication of the FD capability of the network node indicating that the network node supports an FD mode;
obtaining an indication of an FD capability of the UE during an initial access procedure; and
configuring one or more resources for the UE based on the FD capability of the UE.
